(19) United States
(12) Patent Application Publication
(10) Pub. No.: US 2026/0189926 A1
(43) Pub. Date: Jul. 2, 2026

(54) ENHANCED MULTI-ACCESS POINT COORDINATED BEAMFORMING AND SPATIAL REUSE IN WIRELESS COMMUNICATIONS

(71) Applicant: Intel Corporation, Santa Clara, CA (US)

(72) Inventors: Dmitry Akhmetov, Hillsboro, OR (US); Danny Alexander, Neve Efraim Monoson (IL); Danny Ben-Ari, Hod HaSharon (IL); Laurent Cariou, Milizac (FR); Dibakar Das, Hillsboro, OR (US); Juan Fang, Portland, OR (US); Po-Kai Huang, San Ramon, CA (US); Qinghua Li, San Ramon, CA (US); Shlomi Vituri, Tel Aviv (IL)

(21) Appl. No.: 19/531,397

(22) Filed: Feb. 5, 2026

Related U.S. Application Data
(60) Provisional application No. 63/755,083, filed on Feb. 6, 2025.
(60) Provisional application No. 63/757,651, filed on Feb. 12, 2025.
(60) Provisional application No. 63/778,171, filed on Mar. 26, 2025.

(51) Int. Cl. H04W 16/14; H04B 7/024

(52) U.S. Cl. CPC H04W 16/14; H04B 7/024

(57) ABSTRACT

This disclosure describes systems, methods, and devices related to multi-access point coordinated beamforming and coordinated spatial reuse. A device may generate an invitation frame including information associated with synchronized transmissions between the device and a shared access point (AP); send the invitation frame to the shared AP, the invitation frame inviting the shared AP to synchronize transmissions with the device using coordinated beamforming or coordinated spatial reuse based on the information; identify a response frame received from the shared AP and indicating that the shared AP has accepted the invitation to coordinate transmissions with the device based on the information; send a trigger frame, based on the response frame, associated with synchronizing downlink transmissions with the shared AP based on the information; and send, based on the information, a first downlink physical layer protocol data unit (PPDU) in synchronization with a second downlink PPDU of the shared AP.

### CROSS-REFERENCE TO RELATED PATENT APPLICATION(S)

This application claims the benefit of U.S. Provisional Application No. 63/755,083, filed Feb. 6, 2025, U.S. Provisional Application No. 63/757,651, filed Feb. 12, 2025, and U.S. Provisional Application No. 63/778,171, filed Mar. 26, 2025, the disclosures of which are incorporated herein by reference as if set forth in full.

### BACKGROUND

Wireless devices are becoming more prevalent, necessitating efficient access to wireless channels. Standards are evolving to enhance connectivity, integrating advanced technologies in modern networks.

### BRIEF DESCRIPTION OF THE DRAWINGS

FIG. 1 is a network diagram illustrating an example network environment, in accordance with one or more example embodiments of the present disclosure.

FIG. 2 shows a unified exchange sequence for coordinated beamforming and coordinated spatial reuse, in accordance with one or more example embodiments of the present disclosure.

FIG. 3 shows how a beamforming vector and nulling vector impose a constraint on the user grouping of coordinated beamforming, in accordance with one or more example embodiments of the present disclosure.

FIG. 4A shows an option in which a sharing access point only allocates a certain number of streams to a shared access point in a coordinated beamforming invitation, in accordance with one or more example embodiments of the present disclosure.

FIG. 4B shows an option in which a sharing access point allocates a certain number of streams to shared access point in coordinated beamforming invitation, in accordance with one or more example embodiments of the present disclosure.

FIG. 5A shows an option in which no exchange of spatial compatibility is performed after channel sounding and before an initialization phase, in accordance with one or more example embodiments of the present disclosure.

FIG. 5B shows an option in which no exchange of spatial compatibility is performed after channel sounding and before an initialization phase, in accordance with one or more example embodiments of the present disclosure.

FIG. 6 shows an option for coordinated beamforming signaling, in accordance with one or more example embodiments of the present disclosure.

FIG. 7 shows an example sequence for a downlink multi-user coordinated beamforming transmission, in accordance with one or more embodiments of the present disclosure.

FIG. 8 shows an example coordinated spatial reuse mode, in accordance with one or more embodiments of the present disclosure.

FIG. 9 shows an example of coordinated beamforming for stations with multiple antennas, in accordance with one or more embodiments of the present disclosure.

FIG. 10 shows an example of how the availability of a desired channel and interfering channel improve performance even if there are no additional antennas at a station, in accordance with one or more embodiments of the present disclosure.

FIG. 11A shows an example frame exchange sequence for coordinated spatial reuse, in accordance with one or more embodiments of the present disclosure.

FIG. 11B shows an example frame exchange sequence for coordinated spatial reuse, in accordance with one or more embodiments of the present disclosure.

FIG. 11C shows an example frame exchange sequence for coordinated spatial reuse, in accordance with one or more embodiments of the present disclosure.

FIG. 12 shows an example of using different guard interval durations for CSR PPDUs, in accordance with one or more embodiments of the present disclosure.

FIG. 13 shows an example use of an offset to estimate a desired channel of one access point in the presence of another access point's interference, in accordance with one or more embodiments of the present disclosure.

FIG. 14 shows an example of coordinated spatial reuse physical layer protocol data units with different long training field symbol durations, in accordance with one or more embodiments of the present disclosure.

FIG. 15 is a flow for an example process coordinated beamforming and spatial reuse, in accordance with one or more example embodiments of the present disclosure.

FIG. 16 illustrates a functional diagram of an exemplary communication station that may be suitable for use as a user device, in accordance with one or more example embodiments of the present disclosure.

FIG. 17 illustrates a block diagram of an example machine upon which any of one or more techniques (e.g., methods) may be performed, in accordance with one or more example embodiments of the present disclosure.

FIG. 18 is a block diagram of a radio architecture in accordance with some examples.

FIG. 19 illustrates an example front-end module circuitry for use in the radio architecture of FIG. 18, in accordance with one or more example embodiments of the present disclosure.

FIG. 20 illustrates an example radio IC circuitry for use in the radio architecture of FIG. 18, in accordance with one or more example embodiments of the present disclosure.

FIG. 21 illustrates an example baseband processing circuitry for use in the radio architecture of FIG. 18, in accordance with one or more example embodiments of the present disclosure.

### DETAILED DESCRIPTION

The following description and the drawings sufficiently illustrate specific embodiments to enable those skilled in the art to practice them. Other embodiments may incorporate structural, logical, electrical, process, algorithm, and other changes. Portions and features of some embodiments may be included in, or substituted for, those of other embodiments. Embodiments set forth in the claims encompass all available equivalents of those claims.

The IEEE 802.11 technical standards define Wi-Fi® (hereinafter referred to as Wi-Fi) communications, including for coordinated beamforming (CBF/CoBF) and coordinated spatial reuse (SCR/CoSR). CBF and SCR are features in 802.11bn designed to increase network throughput by allowing multiple access points (APs) to transmit simultaneously over a same frequency channel. In CBF, a sharing AP and a shared AP coordinate their transmissions to minimize inter-basic service set (BSS) interference. CSR allows overlapping BSS (OBSS) APs to transmit at the same time by managing interference. Both CBF and CSR rely on a unified signaling structure to facilitate simultaneous transmissions.

Because CBF and CSR involve two APs to send data simultaneously over the same frequency channel using beamforming and nulling, information needs to be exchanged among the APs over a sequence of MAC (medium access control) frames. In addition, information needs to be exchanged among the APs and be collected in one of the APs to trigger two APs to send DL MU CoBF PPDU simultaneously with the same pre-UHR preamble, which may include L-STF, L-LTF, L-SIG, RL-SIG, U-SIG and UHR-SIG.

For CSR, multiple modes have been considered for 802.11bn. In one of the CSR modes, the data PPDUs of sharing AP and shared AP have the same pre-UHR preamble, which consists of L-STF/L-LTF/L-SIG/RL-SIG/U-SIG. Because the number of UHR-SIG symbols is specified in the U-SIG and the U-SIG contents and signals of the two APs are the same, the number of UHR-SIG symbols are the same. Furthermore, the duration of the UHR-STF is the same for all the APs. As a result, the APs start the UHR-LTF at the same time. This causes a problem. The channel training symbols, which are the UHR-LTF symbols sent by the APs, are the same or partially the same when the number of spatial streams of each AP is picked from 1, 2, 3, 4, 7, and 8. Because the training symbols are the same or partially the same, the intended STA cannot distinguish the desired channel from the interfering channel. Instead, the estimated channel is an aggregation of the desired and interfering channels. Even though each STA has multiple antennas, which can mitigate fully or partially the interference from the other AP, the interference may not be mitigated because each STA does not know the desired and interfering channels, respectively.

The present disclosure provides the essential information required in the exchange and proposes frame formats for carrying the information. The present disclosure also provides for how to reuse existing trigger frame format to exchange the information between two APs and trigger the MU CoBF PPDU transmission with minimum change.

In addition, because a problem exists for all existing CSR modes, the idea of allocating additional LTF symbols for learning the interfering channel can be applied to all CSR modes. For allocating additional LTF symbols, besides MU-MIMO PPDU, other PPDU type can be used. For example, one of the APs can use SU PPDU, which carries additional LTF symbols. The additional LTF symbols are for enhancing the channel estimation in the legacy system, but here we reuse them for estimating interfering channels. As another solution to the problem, the two PPDUs may have different guard intervals (GIs) or cyclic prefixes (CPs) such that the LTF symbol boundaries are not aligned. Yet another solution, the PPDUs may use different LTF symbol durations.

In CBF and CSR, there are three phases: (1) initialization phase, (2) transmission phase, and (3) acknowledgement phase. In the initialization phase, the sharing AP acquires the TXOP (transmission opportunity) and invites the shared AP to join the simultaneous CBF transmission. Besides, the sharing and/or the shared AP may send an initial control frame (ICF) to bring its intended STA from low capability state to high capability state. This wakeup process may be optional. Finally, the sharing AP sends a trigger frame (also referred to as a synchronization frame) to ask the shared AP to transmit the data PPDU (physical layer protocol data unit) simultaneously. The spacing between the adjacent frames is short inter frame space (SIFS). The detailed contents and frame formats are proposed in the present disclosure.

The two APs should be able to hear each other, but one AP may not be able to hear the station (STA) of the other AP. To minimize the spacing between adjacent frames or keep the spacing to be SIFS, one AP needs to listen to the other AP's frame even though the frame is for the other AP's STA not for the other AP. For example, the sharing and shared APs shall listen to the ICF of the other AP, which is a trigger frame and specifies the end time of the triggered PPDU, i.e., the ICR, for determining the end time of the responding initial control response (ICR).

For CBF, the information exchange over CBF invitation, CBF response, and CBF trigger determines: (1) a group of STAs served by the APs in the subsequent data transmission phase, and (2) the resource allocation for the selected STAs like spatial stream allocation, PPDU duration, MCS (modulation and coding scheme) of each STA, and other settings of the subfields in the preamble like L-SIG, U-SIG and UHR-SIG of data PPDU.

For the user grouping or STA selection, each AP considers one or more of the following: (1) Buffer status of its STAs. (2) Beamforming vectors of its STAs. (3) Nulling vectors of OBSS STAs. (4) Capability of its STAs, e.g., whether the STA supports 4×4 or 8×8 P-matrix encoded LTF in the data PPDU. (5) The number of spatial streams available to the AP. (6) The duration of the data PPDU. (7) The bandwidth of the data PPDU. (8) ICR availability. If the ICR of a polled STA is not received by the sharing AP, the sharing AP may drop the STA from the CBF trigger and CBF data PPDU.

In the CBF invitation, part or all of the following information may be provided by the sharing AP to the shared AP: (1) The invitation type: CBF, or CSR, or which subtype of CBF or CSR. (2) The duration of the CBF data PPDU. (3) The number of spatial streams allocated to the shared AP. (4) The transmission power of the shared AP. (5) The number of UHR-LTF symbols in the CBF data PPDU. (6) The STA ID of each STA selected by the sharing AP. (7) The STA IDs of the STAs of the shared AP, which are spatially compatible with the selected STAs in (4). (8) The bandwidth of the CBF data PPDU. (9) The MCS of each STA selected by the sharing AP. The MCS may include or exclude information about unequal modulation and extended long range. Some PPDU configuration for the CBF data PPDUs of the two APs, e.g., the packet extension, pre-FEC padding factor, and LDPC extra symbol segment of the CBF data PPDU of both APs. These parameters may pre-defined in the spec such that there is no need to exchange them.

In the CBF response, part or all of the following information may be provided by the shared AP to the sharing AP: (1) The transmission of the CBF response serves as the acknowledgement of the CBF invitation. (2) The STA ID of each STA selected by the shared AP. (3) The stream allocation, MCS, and code type of each STA selected by the shared AP. The MCS may include or exclude information about unequal modulation and extended long range.

In the CBF trigger, part or all of the following information may be provided by the sharing AP to the shared AP. The CBF trigger may serve as the synchronization for OFDM symbol boundary and carrier frequency.

In a first option, because a STA of the sharing AP may not receive the optional ICF, the sharing AP may drop the STA if the sharing AP did not receive the ICR from the STA. Using the CBF trigger frame, the sharing AP tells the shared AP the final resource allocation, MCS, code type, and other PPDU configuration parameters (like the preamble subfields) of the two simultaneous PPDUs so that the two APs can send the SIG fields of the PPDU preamble exactly the same: (1) The STA ID of each STA selected by the two APs. (2) The resource allocation, MCS, and code type of each STA selected by the shared AP. The MCS may include or exclude information about unequal modulation and extended long range. The resource allocation may include stream allocation (and RU allocation).

In a second option, the sharing AP assumes the STAs selected during the CBF invitation and CBF response are always available. There is no need to send the final STA IDs, resource allocation, MCS, code type, and other PPDU configuration parameters: (1) The address of the shared AP. (2) The duration for protecting the CBF data PPDUs and subsequent acknowledgements.

For user grouping schemes, the user selection should be based on a few factors: buffer status, receiver capability status (which can be brought up by ICF), resource availability, spatial compatibility, and STA capability (e.g., whether the reception of length-8 LTF is supported). Neither sharing AP nor shared AP has the full information. Information exchange is needed during the initialization phase. Some information may be exchanged even before the initialization phase, e.g., after the CBF channel sounding and before the CBF invitation. Four user grouping schemes are depicted. It should be noticed that the MCS of each selected STA or user depends on all the beamforming and nulling vectors used by its AP. The less orthogonal the beamforming and nulling vectors, the lower the MCS. The spatial compatibility involves both user selection and stream allocation. Namely, the AP needs to know the stream allocations and the beamforming and nulling vectors of the allocated streams to decide the MCSs. Therefore, the MCSs of the selected STAs are decided in the late stage of user grouping process or initialization phase when most of the selections are done.

The present disclosure proposes that: (1) the MCS of each AP's selected STA should be decided by the AP not the other (OBSS) AP. (2) The MCS of shared AP's selected STA should be sent in CBF response and decided by shared AP. (3) The initial stream allocation of sharing AP's selected STA should be sent in CBF invitation. (4) For implementation simplicity, CBF trigger carries full information about the STA IDs, resource allocations, and MCSs of the CBF data PPDU.

The present disclosure also proposes how to exchange the required information between two APs and trigger the DL MU CoBF PPDU transmission with a single trigger frame format. The proposed idea enabled Wi-Fi 8 to reuse existing trigger frame format to exchange the required information between APs and carry all the required parameters for DL MU CoBF PPDU transmission with minimum change.

802.11bn has agreed to define the pre-UHR portion of the MU PPDU with CoBF enabled as non-beamformed mode. Both two APs need to send the DL MU CoBF PPDU with same content in L-SIG, RL-SIG, U-SIG and UHR-SIG.

The present disclosure proposes that, based on the similarity of the carrying information in CoBF-invite, CoBF-response and CoBF-sync frame, single uniform frame format should be used for these three control frames with several bits to differentiate them. On the other hand, based on carrying information subfields, the current trigger frame format can be used for the CoBF-invite/response/sync frame by reusing one of the existing trigger type such as BSRP or defining it as a new trigger type, which will be indicated by one of the reserved values between 9-15.

For CSR, the present disclosure illustrates that the availability of the desired channel and interfering channel improve the performance even if there are no additional antennas at the STA. Denote the channel matrix of the desired link from sharing AP to its STA by H. Denote the channel matrix of the interfering link from the shared AP to the STA of the sharing AP by G. The ideal linear MMSE receiver of the STA of the sharing AP is given by: W=(H*H+G*G+σ²l)⁻¹H*, (1), where G*G+σ₂l is the covariance matrix of interference plus noise. With the knowledge of the covariance matrix, the STA can suppress the strong interference from a certain direction(s). Besides, the log-likelihood ratios (LLRs) of the demodulated codebits can be calculated accurately such that the LDPC decoding does not degrade. In contrast, without the knowledge of the covariance matrix, the STA cannot suppress the interference using the spatial structure of the interference and cannot calculate the LLRs accurately. The mismatched MMSE receiver of the existing scheme is given by: W=((H+G)*(H+G)+σ²l)⁻¹(H+G)*(2), where H+G is the channel estimated by the STA for decoding its data and σ²l is the covariance matrix of the interference plus noise. As a result, the STA tries to demodulate the summation of the data symbols from the two APs instead of the data symbols from its AP. For non-linear receivers like sphere decoder, the covariance matrix of interference plus noise, i.e., G*G+σ²l, also needs to be known. For the existing scheme, the covariance matrix is estimated as σ²l, which results into performance degradation. The examples herein illustrate the problem at the STA of the sharing AP. The problem is the same at the STA of the shared AP due to symmetry. In the case that the STA has additional antennas, which can be used for mitigating the interference, the unavailability of the interfering channel knowledge prevents the interference mitigation.

In addition to the spatial demultiplexing of the data streams, the spatial demultiplexing of the pilots from the APs also benefits from the knowledge of the desired and interfering channels similarly.

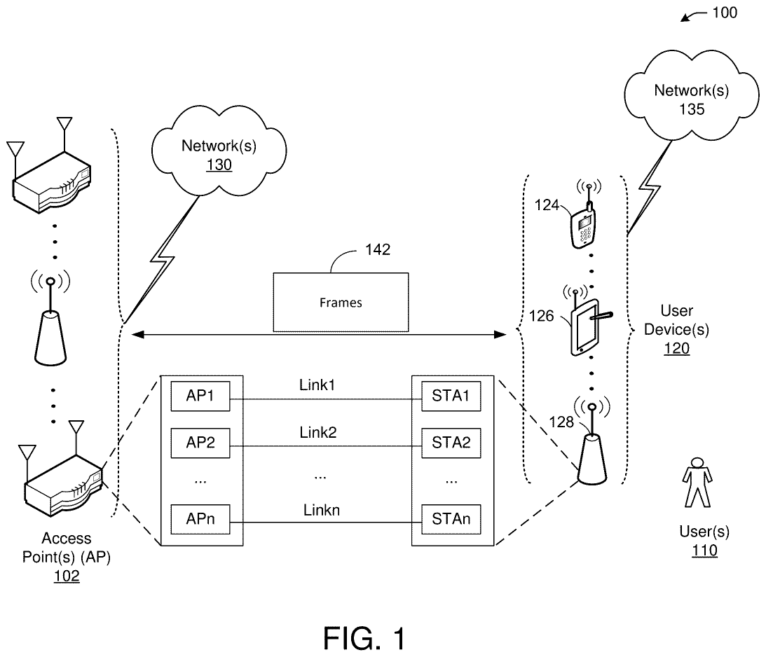

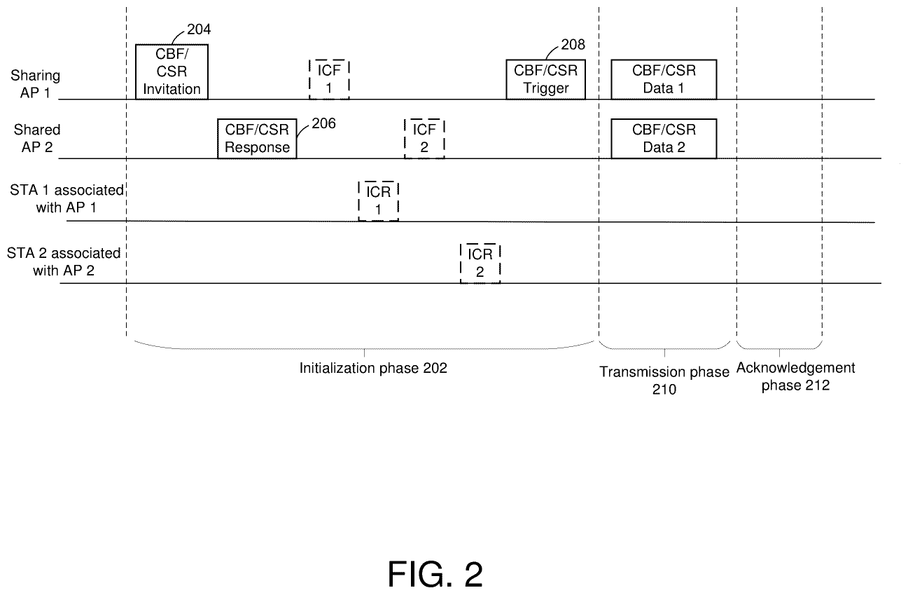

In another mode of CSR, one AP transmits UHR PPDU while the other AP transmits EHT PPDU simultaneously. As an alternative, both APs transmit EHT PPDUs simultaneously. The problem illustrated in FIGS. 2 2 and 3 also exists in the UHR+EHE and EHT+EHT modes as follows. The long training fields (LTFs) like EHT-LTF and UHR-LTF can be fully or partially aligned with each other. When they are fully aligned, the same problem as FIG. 1 occurs. When the LTFs of the two PPDUs are offset by one or two OFDM symbols, the problem remains partially because the LTF symbol sequences, i.e., the P-matrix codes, have a cyclic shift structure.

Because the problem exists for all CSR modes, the idea of allocating additional LTF symbols for learning the interfering channel can be applied to all CSR modes. For allocating additional LTF symbols, besides MU-MIMO PPDU, other PPDU type can be used. For example, one of the APs can use SU PPDU, which carries additional LTF symbols. The additional LTF symbols are for enhancing the channel estimation in the legacy system, but here we reuse them for estimating interfering channels. As another solution to the problem, the two PPDUs may have different guard intervals (GIs) or cyclic prefixes (CPs) such that the LTF symbol boundaries are not aligned. Yet another solution, the PPDUs may use different LTF symbol durations.

The frame exchange sequences for CSR include frame exchange sequences of CSR and CBF that can be unified. For example, the same frame type can be used for triggering CSR and CBF and an indication within the trigger frame indicates which mode of CSR and CBF is triggered. The CSR invitation (or CSR invite or CSR initiation) and CSR response can be ICF and ICR frames addressed to AP instead of STA. The ICF and ICR may be addressed to STAs and are optional.

The present disclosure denotes the mode with two simultaneous UHR PPDUs by UHR+UHR, denote the mode with simultaneous UHR and EHT PPDUs by UHR+EHT, and denotes the mode with two simultaneous EHT PPDUs by EHT+EHT.

The above descriptions are for purposes of illustration and are not meant to be limiting. Numerous other examples, configurations, processes, algorithms, etc., may exist, some of which are described in greater detail below. Example embodiments will now be described with reference to the accompanying figures.

FIG. 1 is a network diagram illustrating an example network environment, according to some example embodiments of the present disclosure. Wireless network 100 may include one or more user devices 120 and one or more access points(s) (AP) 102, which may communicate in accordance with IEEE 802.11 communication standards. The user device(s) 120 may be mobile devices that are non-stationary (e.g., not having fixed locations) or may be stationary devices.

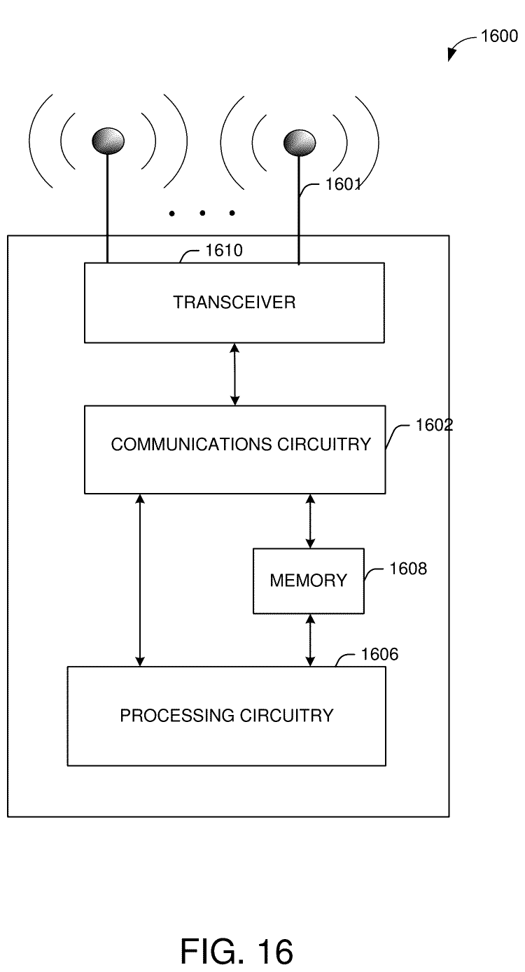

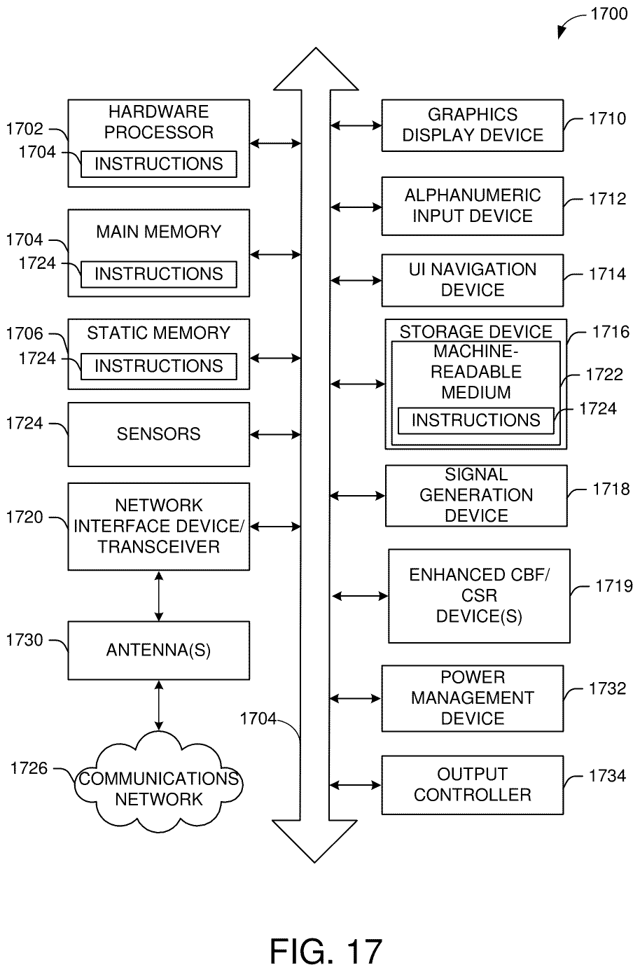

In some embodiments, the user devices 120 and the AP 102 may include one or more computer systems similar to that of the functional diagram of FIG. 16 and/or the example machine/system of FIG. 17.

One or more illustrative user device(s) 120 and/or AP(s) 102 may be operable by one or more user(s) 110. It should be noted that any addressable unit may be a station (STA). An STA may take on multiple distinct characteristics, each of which shape its function. For example, a single addressable unit might simultaneously be a portable STA, a quality-of-service (QOS) STA, a dependent STA, and a hidden STA. The one or more illustrative user device(s) 120 and the AP(s) 102 may be STAs. The one or more illustrative user device(s) 120 and/or AP(s) 102 may operate as a personal basic service set (PBSS) control point/access point (PCP/AP). The user device(s) 120 (e.g., 124, 126, or 128) and/or AP(s) 102 may include any suitable processor-driven device including, but not limited to, a mobile device or a non-mobile, e.g., a static device. For example, user device(s) 120 and/or AP(s) 102 may include, a user equipment (UE), a station (STA), an access point (AP), a software enabled AP (SoftAP), a personal computer (PC), a wearable wireless device (e.g., bracelet, watch, glasses, ring, etc.), a desktop computer, a mobile computer, a laptop computer, an Ultrabook™ computer, a notebook computer, a tablet computer, a server computer, a handheld computer, a handheld device, an internet of things (IoT) device, a sensor device, a PDA device, a handheld PDA device, an on-board device, an off-board device, a hybrid device (e.g., combining cellular phone functionalities with PDA device functionalities), a consumer device, a vehicular device, a non-vehicular device, a mobile or portable device, a non-mobile or non-portable device, a mobile phone, a cellular telephone, a PCS device, a PDA device which incorporates a wireless communication device, a mobile or portable GPS device, a DVB device, a relatively small computing device, a non-desktop computer, a “carry small live large” (CSLL) device, an ultra mobile device (UMD), an ultra mobile PC (UMPC), a mobile internet device (MID), an “origami” device or computing device, a device that supports dynamically composable computing (DCC), a context-aware device, a video device, an audio device, an A/V device, a set-top-box (STB), a blu-ray disc (BD) player, a BD recorder, a digital video disc (DVD) player, a high definition (HD) DVD player, a DVD recorder, a HD DVD recorder, a personal video recorder (PVR), a broadcast HD receiver, a video source, an audio source, a video sink, an audio sink, a stereo tuner, a broadcast radio receiver, a flat panel display, a personal media player (PMP), a digital video camera (DVC), a digital audio player, a speaker, an audio receiver, an audio amplifier, a gaming device, a data source, a data sink, a digital still camera (DSC), a media player, a smartphone, a television, a music player, or the like. Other devices, including smart devices such as lamps, climate control, car components, household components, appliances, etc. may also be included in this list.

As used herein, the term “Internet of Things (IoT) device” is used to refer to any object (e.g., an appliance, a sensor, etc.) that has an addressable interface (e.g., an Internet protocol (IP) address, a Bluetooth identifier (ID), a near-field communication (NFC) ID, etc.) and can transmit information to one or more other devices over a wired or wireless connection. An IoT device may have a passive communication interface, such as a quick response (QR) code, a radio-frequency identification (RFID) tag, an NFC tag, or the like, or an active communication interface, such as a modem, a transceiver, a transmitter-receiver, or the like. An IoT device can have a particular set of attributes (e.g., a device state or status, such as whether the IoT device is on or off, open or closed, idle or active, available for task execution or busy, and so on, a cooling or heating function, an environmental monitoring or recording function, a light-emitting function, a sound-emitting function, etc.) that can be embedded in and/or controlled/monitored by a central processing unit (CPU), microprocessor, ASIC, or the like, and configured for connection to an IoT network such as a local ad-hoc network or the Internet. For example, IoT devices may include, but are not limited to, refrigerators, toasters, ovens, microwaves, freezers, dishwashers, dishes, hand tools, clothes washers, clothes dryers, furnaces, air conditioners, thermostats, televisions, light fixtures, vacuum cleaners, sprinklers, electricity meters, gas meters, etc., so long as the devices are equipped with an addressable communications interface for communicating with the IoT network. IT devices may also include cell phones, desktop computers, laptop computers, tablet computers, personal digital assistants (PDAs), etc. Accordingly, the IoT network may be comprised of a combination of “legacy” Internet-accessible devices (e.g., laptop or desktop computers, cell phones, etc.) in addition to devices that do not typically have Internet-connectivity (e.g., dishwashers, etc.).

The user device(s) 120 and/or AP(s) 102 may also include mesh stations in, for example, a mesh network, in accordance with one or more IEEE 802.11 standards and/or 3GPP standards.

Any of the user device(s) 120 (e.g., user devices 124, 126, 128), and AP(s) 102 may be configured to communicate with each other via one or more communications networks 130 and/or 135 wirelessly or wired. The user device(s) 120 may also communicate peer-to-peer or directly with each other with or without the AP(s) 102. Any of the communications networks 130 and/or 135 may include, but not limited to, any one of a combination of different types of suitable communications networks such as, for example, broadcasting networks, cable networks, public networks (e.g., the Internet), private networks, wireless networks, cellular networks, or any other suitable private and/or public networks. Further, any of the communications networks 130 and/or 135 may have any suitable communication range associated therewith and may include, for example, global networks (e.g., the Internet), metropolitan area networks (MANs), wide area networks (WANs), local area networks (LANs), or personal area networks (PANs). In addition, any of the communications networks 130 and/or 135 may include any type of medium over which network traffic may be carried including, but not limited to, coaxial cable, twisted-pair wire, optical fiber, a hybrid fiber coaxial (HFC) medium, microwave terrestrial transceivers, radio frequency communication mediums, white space communication mediums, ultra-high frequency communication mediums, satellite communication mediums, or any combination thereof.

Any of the user device(s) 120 (e.g., user devices 124, 126, 128) and AP(s) 102 may include one or more communications antennas. The one or more communications antennas may be any suitable type of antennas corresponding to the communications protocols used by the user device(s) 120 (e.g., user devices 124, 126 and 128), and AP(s) 102. Some non-limiting examples of suitable communications antennas include Wi-Fi antennas, Institute of Electrical and Electronics Engineers (IEEE) 802.11 family of standards compatible antennas, directional antennas, non-directional antennas, dipole antennas, folded dipole antennas, patch antennas, multiple-input multiple-output (MIMO) antennas, omnidirectional antennas, quasi-omnidirectional antennas, or the like. The one or more communications antennas may be communicatively coupled to a radio component to transmit and/or receive signals, such as communications signals to and/or from the user devices 120 and/or AP(s) 102.

Any of the user device(s) 120 (e.g., user devices 124, 126, 128), and AP(s) 102 may be configured to perform directional transmission and/or directional reception in conjunction with wirelessly communicating in a wireless network. Any of the user device(s) 120 (e.g., user devices 124, 126, 128), and AP(s) 102 may be configured to perform such directional transmission and/or reception using a set of multiple antenna arrays (e.g., DMG antenna arrays or the like). Each of the multiple antenna arrays may be used for transmission and/or reception in a particular respective direction or range of directions. Any of the user device(s) 120 (e.g., user devices 124, 126, 128), and AP(s) 102 may be configured to perform any given directional transmission towards one or more defined transmit sectors. Any of the user device(s) 120 (e.g., user devices 124, 126, 128), and AP(s) 102 may be configured to perform any given directional reception from one or more defined receive sectors.

MIMO beamforming in a wireless network may be accomplished using RF beamforming and/or digital beamforming. In some embodiments, in performing a given MIMO transmission, user devices 120 and/or AP(s) 102 may be configured to use all or a subset of its one or more communications antennas to perform MIMO beamforming.

Any of the user devices 120 (e.g., user devices 124, 126, 128), and AP(s) 102 may include any suitable radio and/or transceiver for transmitting and/or receiving radio frequency (RF) signals in the bandwidth and/or channels corresponding to the communications protocols utilized by any of the user device(s) 120 and AP(s) 102 to communicate with each other. The radio components may include hardware and/or software to modulate and/or demodulate communications signals according to pre-established transmission protocols. The radio components may further have hardware and/or software instructions to communicate via one or more Wi-Fi and/or Wi-Fi direct protocols, as standardized by the Institute of Electrical and Electronics Engineers (IEEE) 802.11 standards. In certain example embodiments, the radio component, in cooperation with the communications antennas, may be configured to communicate via 2.4 GHz channels (e.g. 802.11b, 802.11g, 802.11n, 802.11ax), 5 GHz channels (e.g. 802.11n, 802.11ac, 802.11ax, 802.11be, 802.11bn, etc.), 6 GHz channels (e.g., 802.11ax, 802.11be, 802.11bn, etc.), 60 GHz channels (e.g. 802.11ad, 802.11ay), or 42 GHz-71 GHz channels (802.11bq). 800 MHz channels (e.g. 802.11ah). The communications antennas may operate at 28 GHz and 40 GHz. It should be understood that this list of communication channels in accordance with certain 802.11 standards is only a partial list and that other 802.11 standards may be used (e.g., Next Generation Wi-Fi, or other standards). In some embodiments, non-Wi-Fi protocols may be used for communications between devices, such as Bluetooth, dedicated short-range communication (DSRC), Ultra-High Frequency (UHF) (e.g. IEEE 802.11af, IEEE 802.22), white band frequency (e.g., white spaces), or other packetized radio communications. The radio component may include any known receiver and baseband suitable for communicating via the communications protocols. The radio component may further include a low noise amplifier (LNA), additional signal amplifiers, an analog-to-digital (A/D) converter, one or more buffers, and digital baseband.

In one embodiment, and with reference to FIG. 1, a user device 120 may be in communication with one or more APs 102. For example, one or more APs 102 may exchange frames 142 with one or more user devices 120. The frames 142 may include CBF signaling and frames, CSR signaling and frames, and other frames as defined herein.

The one or more APs 102 may be multi-link devices (MLDs) and the one or more user device 120 may be non-AP MLDs. Each of the one or more APs 102 may comprise a plurality of individual APs (e.g., AP1, AP2, . . . , APn, where n is an integer) and each of the one or more user devices 120 may comprise a plurality of individual STAs (e.g., STA1, STA2, . . . , STAn). The AP MLDs and the non-AP MLDs may set up one or more links (e.g., Link1, Link2, . . . , Linkn) between each of the individual APs and STAs.

It is understood that the above descriptions are for the purposes of illustration and are not meant to be limiting.

FIG. 2 shows a unified exchange sequence for CBF and CSR, in accordance with one or more example embodiments of the present disclosure.

Referring to FIG. 2, during an initialization phase 202, a sharing AP 1 may send a CBF/CSR invitation 204 to invite a shared AP 2 to join a simultaneous CBF transmission. The shared AP 2 may send a CBF/CSR response 206 accepting the invitation 204. The sharing AP 1 may send an ICF 1 to bring its intended STA (e.g., STA 1 associated with AP 1) from a low-capability state to a high-capability state, and the shared AP 2 may send an ICF 2 to bring its intended STA (e.g., STA 2 associated with AP 2) from a low-capability state to a high-capability state. STA 1 may respond with an ICR 1, and STA 2 may respond with an ICR 2. This wakeup process may be optional.

Still referring to FIG. 2, the sharing AP 1 may send a CBF/CSR trigger frame 208 (also referred to as a synchronization frame) to ask the shared AP 2 to transmit data PPDUs simultaneously (e.g., CBF/CSR Data 1 and CBF/CSR Data 2) during a transmission phase 110. The transmission phase 210 may be followed by an acknowledgement phase 112.

The two APs should be able to hear each other, but one AP may not be able to hear the station (STA) of the other AP. To minimize the spacing between adjacent frames or keep the spacing to be SIFS, one AP needs to listen to the other AP's frame even though the frame is for the other AP's STA not for the other AP. For example, the sharing and shared APs shall listen to the ICF of the other AP, which is a trigger frame and specifies the end time of the triggered PPDU, i.e., the ICR, for determining the end time of the responding initial control response (ICR).

For CBF, the information exchange over CBF invitation, CBF response, and CBF trigger determines: (1) a group of STAs served by the APs in the subsequent data transmission phase, and (2) the resource allocation for the selected STAs like spatial stream allocation, PPDU duration, MCS (modulation and coding scheme) of each STA, and other settings of the subfields in the preamble like L-SIG, U-SIG and UHR-SIG of data PPDU.

For the user grouping or STA selection, each AP considers one or more of the following: (1) Buffer status of its STAs. (2) Beamforming vectors of its STAs. (3) Nulling vectors of OBSS STAs. (4) Capability of its STAs, e.g., whether the STA supports 4×4 or 8×8 P-matrix encoded LTF in the data PPDU. (5) The number of spatial streams available to the AP. (6) The duration of the data PPDU. (7) The bandwidth of the data PPDU. (8) ICR availability. If the ICR of a polled STA is not received by the sharing AP, the sharing AP may drop the STA from the CBF trigger and CBF data PPDU.

In the CBF invitation, part or all of the following information may be provided by the sharing AP to the shared AP: (1) The invitation type: CBF, or CSR, or which subtype of CBF or CSR. (2) The duration of the CBF data PPDU. (3) The number of spatial streams allocated to the shared AP. (4) The transmission power of the shared AP. (5) The number of UHR-LTF symbols in the CBF data PPDU. (6) The STA ID of each STA selected by the sharing AP. (7) The STA IDs of the STAs of the shared AP, which are spatially compatible with the selected STAs in (4). (8) The bandwidth of the CBF data PPDU. (9) The MCS of each STA selected by the sharing AP. The MCS may include or exclude information about unequal modulation and extended long range. Some PPDU configuration for the CBF data PPDUs of the two APs, e.g., the packet extension, pre-FEC padding factor, and LDPC extra symbol segment of the CBF data PPDU of both APs. These parameters may pre-defined in the spec such that there is no need to exchange them.

In the CBF response, part or all of the following information may be provided by the shared AP to the sharing AP: (1) The transmission of the CBF response serves as the acknowledgement of the CBF invitation. (2) The STA ID of each STA selected by the shared AP. (3) The stream allocation, MCS, and code type of each STA selected by the shared AP. The MCS may include or exclude information about unequal modulation and extended long range.

In the CBF trigger, part or all of the following information may be provided by the sharing AP to the shared AP. The CBF trigger may serve as the synchronization for OFDM symbol boundary and carrier frequency.

In a first option, because a STA of the sharing AP may not receive the optional ICF, the sharing AP may drop the STA if the sharing AP did not receive the ICR from the STA. Using the CBF trigger frame, the sharing AP tells the shared AP the final resource allocation, MCS, code type, and other PPDU configuration parameters (like the preamble subfields) of the two simultaneous PPDUs so that the two APs can send the SIG fields of the PPDU preamble exactly the same: (1) The STA ID of each STA selected by the two APs. (2) The resource allocation, MCS, and code type of each STA selected by the shared AP. The MCS may include or exclude information about unequal modulation and extended long range. The resource allocation may include stream allocation (and RU allocation).

In a second option, the sharing AP assumes the STAs selected during the CBF invitation and CBF response are always available. There is no need to send the final STA IDs, resource allocation, MCS, code type, and other PPDU configuration parameters: (1) The address of the shared AP. (2) The duration for protecting the CBF data PPDUs and subsequent acknowledgements.

For spatial compatibility in CBF, the beamforming vector and nulling vector impose a constraint on the user grouping of CBF. In the figure, from the sharing AP's perspective, its STA and the STA of the shared AP are in roughly the same direction. Namely, the beamforming vector and the nulling vector are highly correlated. In this case, most of the transmission power of the sharing AP is wasted in pre-canceling the interference, i.e., the nulling the interference to the shared AP's STA. Therefore, grouping the two STAs is undesirable from the sharing AP's perspective. It is interesting to note that the two STAs look fine from the shared AP's perspective because the directions to the two STAs are quite different. Namely, the beamforming vector and nulling vector are close to orthogonal from the shared AP's perspective. After the channel sounding, each AP may only have the beamforming vectors and nulling vectors from its perspective. In other words, each AP may only know the beamforming and nulling vectors of its own and does not the vectors of the other AP. Therefore, information exchange is needed to find a compatible user group. Namely, the spatial compatibility requires cross checks.

For user wakeup, after the user grouping, the shared and sharing APs may wake up their selected STAs using ICF/ICR exchanges. This wakeup may be optional for the APs.

For bandwidth consistency, for holding the channel acquired by the sharing AP, the bandwidth of the CBF response frame should be the same as the CBF invitation bandwidth and the bandwidth is the same as the data PPDU bandwidth. The spec can mandate this bandwidth consistency. If so, the bandwidth of the data PPDU may not need to be explicitly specified in CBF invitation or CBF response or CBF trigger.

Regarding the frame format of the CBF invitation, the present disclosure provides a frame format type indication. The frame format of CBF invitation can be of a type of trigger frame like Buffer Status Report Poll (BSRP), or Basic, or can be a new trigger frame type indicated by one of the reserved values 9-15 in Table 9-46b for Trigger Type subfield (802.11be). The RA filed should be set to the address of shared AP so that the STA does not need to read the CBF invitation. The trigger frame type of the CBF invitation may be indicated using one of the three leftover entries in Table 9-46a (802.11be). Alternatively, the CBF invitation can be indicated by one or multiple bits of the reserved bits B56-B63 in the common info field. Because 320 MHz bandwidth needs to be supported, HE variant is undesirable. Instead, EHT variant or UHR variant is desirable. Table 1 below represents Table 9-46a of 802.11be:

TABLE 1
Valid Combinations of B54 and B55 in the Common Info Field,
B39 in the User Info Field, and Solicited TB PPDU Format:

| Common | Common | User | Presence of | User Info | TB |
|---|---|---|---|---|---|
| Info | Info | Info | Special User | field | PPDU |
| field B54 | field B55 | field B39 | Info field | variant | type |
| 1 | 1 | 0 | No | HE variant | HE |
| 0 | 0 | 0 | Yes | EHT variant | EHT |
| 0 | 0 | 1 | Yes | EHT variant | EHT |
| 1 | 0 | 1 | Yes | EHT variant | EHT |
| 1 | 0 | 0 | Yes | HE variant | HE |

Table 2 below represents Table 9-46b of 802.11be:

TABLE 2
Trigger Type Subfield Encoding:

| Trigger Type subfield value | Trigger frame variant |
|---|---|
| 0 | Basic |
| 1 | Beamforming Report Poll (BFRP) |
| 2 | MU-BAR |
| 3 | MU-RTS |
| 4 | Buffer Status Report Poll (BSRP) |
| 5 | GCR MU-BAR |
| 6 | Bandwidth Query Report Poll (BQRP) |
| 7 | NDP Feedback Report Poll (NFRP) |
| 8 | Ranging |
| 9-15 | Reserved |

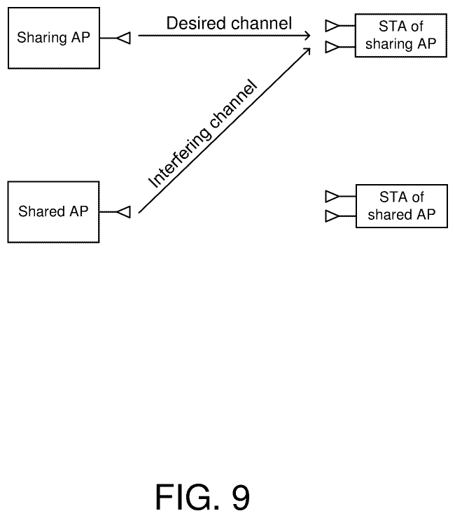

In the common info field of the trigger frame, the EHT variant of common info field, which is shown in FIG. 9-90b (802.11be), can be reused with slight changes on the definitions of some subfields. The subfields should be redefined for downlink PPDU and UHR instead of uplink PPDU and EHT. For example, the UL Length is redefined as DL Length for indicating the CBF data PPDU duration such that the Length field of L-SIG of the CBF data PPDU can be set accordingly. For another example, the UL W is redefined as DL BW for indicating the bandwidth of the CBF data PPDU. UL Spatial Reuse is not used for CBF. The subfield, Number of HE/EHT-LTF Symbols, indicates the number of UHR-LTF symbols in the CBF data PPDU. The AP Tx Power indicates the transmit power of shard AP. GI And HE/EHT-LTF Type can be redefined as GI And HE/EHT/UHR-LTF Type to include UHR. HE/EHT P160 can be redefined as HE/EHT/UHR P160 to include UHR. Other subfields like Extra LDPC Symbol Segment, PE Disambiguity, and Pre-FEC Padding Factor can be reused. Special User Info Field may be present in the CBF invitation for supporting 320 MHz bandwidth. The EHT format of the special user info field is shown in FIG. 9-90d (802.11be). To support CBF, the subfields in FIG. 9-90d should be redefined for downlink data PPDU instead of uplink PPDU. Trigger Dependent Common Info may not be present. Table 3 below represents FIG. 9-90b of 802.11be.

TABLE 3
EHT Variant Common Info Field Format:

| | | | | | | |
|---|---|---|---|---|---|---|
| Field: | Trigger Type | UL Length | More TF | CS | UL BW | GI and |
| | | | | Required | | HE/EHT- |
| | | | | | | LTF |
| | | | | | | Type/TXS |
| | | | | | | Mode |
| Bits: | B0-B3 | B4-B15 | B16 | B17 | B18-B19 | B20-B21 |
| Field: | Reserved | Number of | Reserved | LDPC | AP TX | Pre-FEC |
| | | HE/EHT- | | Extra | Power | Padding |
| | | LTF | | Symbol | | Factor |
| | | Symbols | | Segment | | |
| Bits: | B22 | B23-B25 | B26 | B27 | B28-B33 | B34-B35 |
| Field: | PE | UL Spatial | Reserved | HE/EHT | Special | EHT |
| | Disambiguity | Reuse | | P160 | User Info | Reserved |
| | | | | | Field Flag | |
| Bits: | B36 | B37-B52 | B53 | B54 | B55 | B56-B62 |

| | | |
|---|---|---|
| Field: | Reserved | Trigger Dependent Common Info |
| Bits: | B63 | Variable |

Table 4 below represents FIG. 9-90d of 802.11be:

TABLE 4
Special User Info Field Format:

| | | | | | | | | |
|---|---|---|---|---|---|---|---|---|
| Field: | AID12 | PHY | UL BW | EHT | EHT | U-SIG | Reserved | Trigger |
| | | Version | Extension | Spatial | Spatial | Disregard | | Dependent |
| | | ID | | Reuse | Reuse | and | | Common |
| | | | | 1 | 2 | Validate | | Info |
| Bits: | B0-B11 | B12-B14 | B15-B16 | B17-B20 | B21-B24 | B25-B36 | B37-B39 | Variable |

For the user info field, the STA IDs of the STAs selected by the sharing AP and the STA IDs of the compatible STAs of the shared AP are in the User Info fields, respectively. The MCSs and the stream allocations of the STAs selected by the sharing AP also need to be specified in the user info fields. The user info fields of EHT and UHR are shown FIG. 9-90i of 80211.be, Table 5, Table 6, and Table 7, respectively. It can be reused for CBF invitation with slight changes in definitions. The subfields should be redefined for downlink PPDU and UHR instead of uplink PPDU and EHT. The subfield, UL Target Receiver Power, is not needed for CBF and the seven bits of the subfield can be redefined for CBF parameters. For example, an indication is needed to indicate whether the user info field is for a STA of the sharing AP or the shared AP. If the user info field is for the sharing AP, then the user or STA with the AID is selected by the sharing AP for the data transmission and the MCS and stream allocation are specified in the user info field. Otherwise, if the user info field is for the shared AP, then the user or STA is a candidate STA, which may be compatible with the STAs selected by the sharing AP. One bit from B32-B38 may be used as the AP indication that indicates which AP the user info field belongs to. Because the MCS set of UHR is larger than that of EHT, additional bits are needed to indicate MCS (including unequal modulation) and code type. Therefore, UHR variant user info field format is more desirable than EHT variant.

Table 5 below represents FIG. 9-90i of 80211.be.

TABLE 5
EHT Variant User Info Field Format:

| | | | | | | | |
|---|---|---|---|---|---|---|---|
| Field: | AID12 | RU | UL | UL | Reserved | SS | UL Target |
| | | Allocation | FEC | EHT- | | Allocation | RX Power |
| | | | Coding | MCS | | | |
| | | | Type | | | | |
| Bits: | B0-B11 | B12-B19 | B20 | B21-B24 | B25 | B26-B31 | B32-B38 |

| | | |
|---|---|---|
| Field: | PS160 | Trigger Dependent User Info |
| Bits: | B39 | Variable |

TABLE 6
UHR Variant User Info Field Format:

| | | | | | | | |
|---|---|---|---|---|---|---|---|
| Field: | AID12 | RU | UL | UL | 2x | SS | UL Target |
| | | Allocation | FEC | UHR- | LDPC | Allocation | RX Power |
| | | | Coding | MCS | (New) | (New) | |
| | | | Type | (New) | | | |
| Bits: | B0-B11 | B12-B19 | B20 | B21-B25 | B26 | B27-B31 | B32-B38 |

| | | |
|---|---|---|
| Field: | PS160 | Trigger Dependent User Info |
| Bits: | B39 | Variable |

TABLE 7
SS Allocation Subfield Formato of a UHR Variable
User Info Field (50 bit design) if rRU:

| | | |
|---|---|---|
| Field: | Starting Stream Index | Number of Spatial Streams |
| Bits: | B0-B2 | B3-B4 |

TABLE 8
SS Allocation Subfield Formato of a UHR Variable
User Info Field (50 bit design) if dRU:

| | | | |
|---|---|---|---|
| Field: | Distribution | Reserved | Number of |
| | BW | | Spatial Streams |
| Bits: | B0-B11 | B2-B3 | B4 |

Instead of being inside the user info field, the AP indication may be outside the user info field, e.g., in the common info field, the special user info field, trigger dependent common info field, and trigger dependent user info field. For example, the AP indication may be a counter of user info field. Number k indicates that the first k user info fields (including or excluding special user info field) are for the selected STAs of the sharing AP and the rest of the user info fields are the (compatible) STAs of the shared AP. If BSRP format is used for the CBF invitation, the AP indication may be in the special user info field because the trigger dependent common info field and trigger dependent user info field are not present.

The frame format of CBF response can be of a type of Multi-STA BlockAck or trigger frame like Basic trigger, Buffer Status Report Poll (BSRP), or can be a new trigger frame type indicated by one of the reserved values 9-15 in Table 9-46b for Trigger Type subfield (802.11be). The RA filed may be set to the address of sharing AP so that the STA does not need to read the CBF response. The trigger frame type of the CBF response may be indicated using one of the three leftover entries in Table 9-46a. Or, the CBF response can be indicated by one or multiple bits of the reserved bits B56-B63 in common info field. Because 320 MHz bandwidth needs to be supported, HE variant is undesirable. Instead, EHT variant or UHR variant is desirable.

In a first option using a multi-STA block acknowledgement (BlockAck), the general format of the BlockAck is shown below in Table 9, representing FIG. 9-52 of 802.11be. The RA may be set to the address of the sharing AP.

TABLE 9
BlockAck Frame Format:

| Field: | Frame | Duration | RA | TA | BA | BA Info | FCS |
|---|---|---|---|---|---|---|---|
| | Control | | | | Control | | |
| Octets: | 2 | 2 | 6 | 6 | 2 | Variable | 4 |

The format of the BA Control field is shown in FIG. 9-53 of 802.11be, represented by Table 10 below. The BA Type can be set to Multi-STA BlockAck with value 11 as shown in Table 9-37 of 802.11be, represented by Table 11 below. Or, the BA type can be set to a new type with a value between 12-15.

TABLE 10
BA Control Field Format (802.11ax/ay):

| | | | | | | | |
|---|---|---|---|---|---|---|---|
| Field: | Reserved | BA | Reserved | No | Memory | Management | TID_Info |
| | | Type | | Memory | Config | Ack | |
| | | | | Kept | Tag | | |
| Bits: | B0 | B1-B4 | B5-B8 | B9 | B10 | B11 | B12-B15 |

TABLE 11
BlockAck Frame Variant Encoding (802.11ax):

| BA Type | BlockAck frame variant |
|---|---|
| 0 | Reserved |
| 1 | Extended Compressed |
| 2 | Compressed |
| 3 | Reserved(#6599) |
| 4-5 | Reserved |
| 6 | GCR |
| 7(11ay) | EDMG Multi-TID |
| 8(11ay) | EDMG Compressed |
| 9(11ay) | Reserved |
| 10 | GLK-GCR |
| 11 | Multi-STA |
| 12-15 | Reserved |

If BA Type is set to Multi-STA BlockAck, the BA Information field in FIG. 9-52 consists of one or more Per AID TID Info subfields, whose format is shown in FIG. 9-60 of 802.11be, represented by Table 12 below.

TABLE 12
Per AID TID Info Subfield Format if
the AID11 Subfield is not 2045:

| | | | |
|---|---|---|---|
| Field: | AID TID | Block Ack Starting | Block Ack Bitmap |
| | Info | Sequence Control | |
| Octets: | 2 | 0 or 2 | 0, 4, 8, 16, 32, |
| | | | 64, or 128 |

For CBF response, the STA ID, resource allocation (like stream allocation and RU allocation), MCS, and code type of each STA selected by the shared AP is specified in the Per AID TID Info subfield, one for each STA. The STA ID can be indicated in the AID subfield in the AID TID Info subfield, whose format is shown in FIG. 9-59 of 802.11be, represented by Table 13 below. The resource allocation, MCS, and code type can be specified in a subfield after AID TID Info subfield. The subfield be the Block Ack Starting Sequence Control subfield or a new subfield. The length of the subfield may be 2-3 bytes, i.e., 16-24 bits, which is enough to cover the indications of resource allocation, MCS, and code type. Formats of the resource allocation (like stream allocation), MCS, and code type can be the same as those in user info field of UHR trigger frame. If so, 16 bits are enough.

TABLE 13
AID TID Info Subfield Format (802.11ax):

| | | | |
|---|---|---|---|
| Field: | AID11 | Ack Type | TID |
| Bits: | B0-B10 | B11 | B12-B15 |

Because the BlockAck Starting Sequence Control subfield and the Block Ack Bitmap subfield are present and absent simultaneously in the legacy modes, as shown in Table 9-39 of 802.11be, represented by Table 14 below, a new mode needs to be defined using one of the reserved combinations in Table 9-39. For example, Ack Type is set to 1 and TID is set to 8.

In a second option using a trigger frame, the frame format of CBF response can be of a type of trigger frame like Basic, Buffer Status Report Poll (BSRP), BQRP, or can be a new trigger frame type. The format can be similar to that of CFB invitation. In CBF response, only the STA selected by the shared AP is specified, one per user info field.

For a frame format of a DBF trigger, the present disclosure provides a frame type indication. There are two options for CBF trigger. In Option 1, CBF trigger carries the full information about STAs selected for the data PPDU transmissions of the two APs. The full information includes STA IDs (e.g., AIDs), resource allocation (e.g., stream allocation and PPDU length), MCSs, and code types. The format of the CBF trigger can be of trigger frame type like BSRP, BQRP, or Basic, which has a common info field and user info fields. The common field may include the PHY parameters like Pre-FEC Padding Factor, LDPC Extra Symbol Segment, and PE ambiguity that are common for all the selected STAs of the two APs. Because the trigger dependent common info field and trigger dependent user info field are not needed for the CBF trigger frame, BSRP and BQRP formats are desirable.

In Option 2, CBF trigger does not carry the full information about the STAs selected for the data PPDU transmissions because some information (like resource allocation and PHY parameters) was sent already in the preceding CBF invitation and CBF response. The frame format of the CBF trigger may be of a control frame like RTS, CTS, ACK, and Multi-STA BlockAck. The STA IDs of the selected STAs by the two APs may or may not be included in the CBF trigger. If the IDs like AIDs are included, then Multi-STA BlockAck is the desirable. The RA of the CBF trigger may be the address of the shared AP.

TABLE 14
Context of the Per AID TID Info Subfield and Presence of Optional
Subfields if the AID11 Subfield is not 2045 (80211ax):

| | | Presence of | |
|---|---|---|---|
| | | Block Ack | |
| Ack | | Starting Sequence | |
| Type | TID | Control subfield | Context of a Per AID TID Info |
| subfield | subfield | and Block Ack | subfield in a Multi-STA |
| values | values | Bitmap subfields | BlockAck frame |
| 0 | 0-7 | Present | Block acknowledgment context: |
| | | | Sent as an acknowledgment to |
| | | | QoS Data frames that solicit a |
| | | | BlockAck frame response or to a |
| | | | BlockAckReq frame. |
| 1 | 0-7 | Not present | Acknowledgment context: Sent as |
| | | | an acknowledgment to a QoS Data |
| | | | or QoS Null frame that solicits |
| | | | an Ack frame response. |
| 0 or 1 | 8-13 | N/A | Reserved |
| 0 | 14 | N/A | Reserved |
| 1 | 14 | Not present | All ack context: Sent as an |
| | | | acknowledgment to an A-MPDU |
| | | | that contains an MPDU that solicits |
| | | | an immediate response and all |
| | | | MPDUs contained in the A-MPDU |
| | | | are received successfully. |
| 0 | 15 | N/A | Reserved |
| 1 | 15 | Not present | Management/PS-Poll frame |
| | | | acknowledgment context: Sent as |
| | | | an acknowledgment to a |
| | | | Management or PS-Poll frame. |

NOTE 1
Additional rules for acknowledgment, block acknowledgment and the all ack context are defined in 26.4.2 (Acknowledgment context in a Multi-STA BlockAck frame) for a multi-TID A-MPDU.
NOTE 2
As HE STAs do not use HCCA (see 10.23.1 (General)), TID values from 8 to 15 are not used in QoS Data frames.

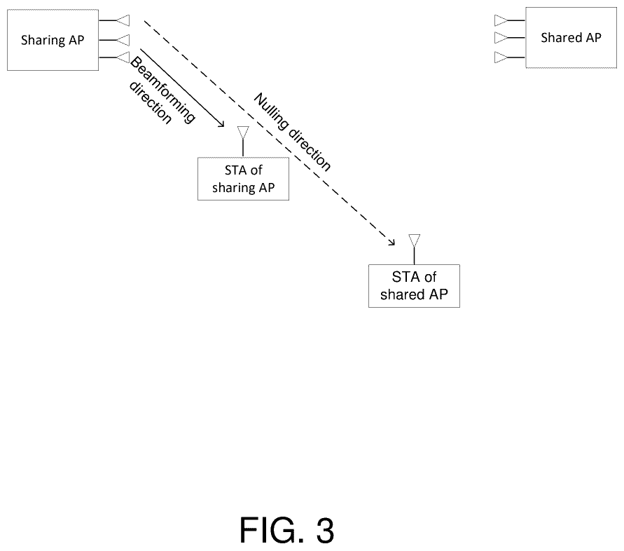

FIG. 3 shows how a beamforming vector and nulling vector impose a constraint on the user grouping of CBF, in accordance with one or more example embodiments of the present disclosure.

Referring to FIG. 3, from the sharing AP's perspective, its STA and the STA of the shared AP are in roughly the same direction. Namely, the beamforming vector and the nulling vector are highly correlated. In this case, most of the transmission power of the sharing AP is wasted in pre-canceling the interference, i.e., the nulling the interference to the shared AP's STA. Therefore, grouping the two STAs is undesirable from the sharing AP's perspective. It is interesting to note that the two STAs look fine from the shared AP's perspective because the directions to the two STAs are quite different. Namely, the beamforming vector and nulling vector are close to orthogonal from the shared AP's perspective. After the channel sounding, each AP may only have the beamforming vectors and nulling vectors from its perspective. In other words, each AP may only know the beamforming and nulling vectors of its own and does not the vectors of the other AP. Therefore, information exchange is needed to find a compatible user group. Namely, the spatial compatibility requires cross checks.

For spatial compatibility in CBF, the beamforming vector and nulling vector impose a constraint on the user grouping of CBF. In the figure, from the sharing AP's perspective, its STA and the STA of the shared AP are in roughly the same direction. Namely, the beamforming vector and the nulling vector are highly correlated. In this case, most of the transmission power of the sharing AP is wasted in pre-canceling the interference, i.e., the nulling the interference to the shared AP's STA. Therefore, grouping the two STAs is undesirable from the sharing AP's perspective. It is interesting to note that the two STAs look fine from the shared AP's perspective because the directions to the two STAs are quite different. Namely, the beamforming vector and nulling vector are close to orthogonal from the shared AP's perspective. After the channel sounding, each AP may only have the beamforming vectors and nulling vectors from its perspective. In other words, each AP may only know the beamforming and nulling vectors of its own and does not the vectors of the other AP. Therefore, information exchange is needed to find a compatible user group. Namely, the spatial compatibility requires cross checks.

To select a compatible user group, the sharing AP may provide two STA lists, i.e., selected STA list and compatible OBSS STA list. The first list consists of the STAs of the sharing AP, which are selected to be served in the subsequent data transmission, e.g., according to buffer statuses and the spatially compatibility among the selected STAs. The second list consists of the STAs of the shared AP, which are spatially compatible with the STAs in the first list. The two lists are sent to the shared AP via the CBF invitation frame. Together with the two lists, the sharing AP may send the data PPDU duration, data PPDU bandwidth, and the spatial stream allocation to the shared AP.

According to the buffer statuses, the PPDU duration, the PPDU bandwidth, the allocated spatial streams, and the spatial compatibility with the STAs selected by the sharing AP, the shared AP selects its STAs, e.g., from the compatible OBSS STA list provided by the sharing AP. The shared AP sends the list of its selected STAs, the resource allocations, and the MCSs of the selected STAs to the sharing AP via the CBF response frame. The resource allocations consist of the spatial stream allocation to the STA selected by the shared AP and maybe the bandwidth allocation to the STAs.

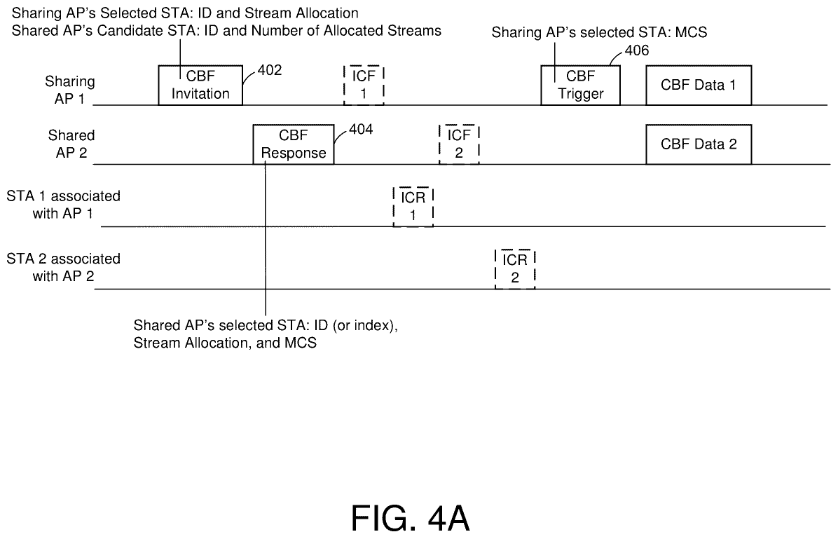

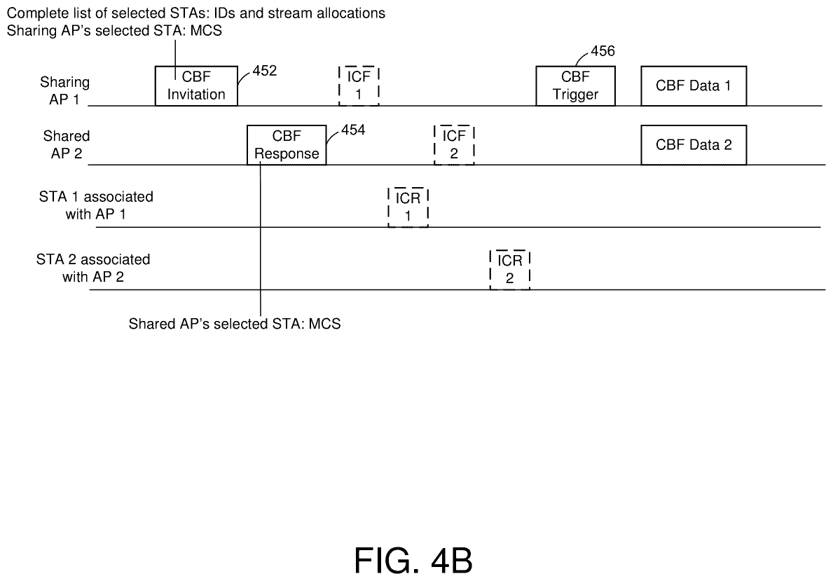

FIG. 4A shows an option in which a sharing AP only allocates a certain number of streams to shared AP in CBF invitation, in accordance with one or more example embodiments of the present disclosure. How the allocated streams are allocated to the shared AP's selected STAs is up to the shared AP.

Referring to FIG. 4A, a CBF invitation 402 sent by a sharing AP 1 may include the sharing AP's selected STA ID and stream allocation, and/or the shared AP's candidate STA ID and number of allocated streams (e.g., for STA 1 associated with AP 1). A CBF response 404 sent by a shared AP 2 may include the shared AP's selected STA ID (or index), a stream allocation, and/or MCS (e.g., for STA 2 associated with AP 2). When the sharing AP 1 sends a CBF trigger frame 406, it may include the sharing AP's selected STA MCS.

Optionally, the sharing AP 1 may wake up the STA 1 with an ICF 1, to which the STA 1 may respond with an ICR 1. Similarly, the shared AP 2 may wake up the STA 2 with an ICF 2, to which the STA 2 may respond with an ICR 2. The CBF trigger frame 406 may trigger simultaneous transmission of CBF data 1 and CBF data 2.

FIG. 4B shows an option in which a sharing AP allocates a certain number of streams to shared AP in CBF invitation, in accordance with one or more example embodiments of the present disclosure.

Referring to FIG. 4B, a CBF invitation 452 sent by a sharing AP 1 may include the sharing AP's selected STA ID and stream allocation, and/or the shared candidate STA ID and stream allocation (e.g., for STA 1 associated with AP 1). A CBF response 454 sent by a shared AP 2 may include the shared AP's selected STA ID (or index), and/or MCS (e.g., for STA 2 associated with AP 2). When the sharing AP 1 sends a CBF trigger frame 456, it may include the sharing AP's selected STA MCS.

Optionally, the sharing AP 1 may wake up the STA 1 with an ICF 1, to which the STA 1 may respond with an ICR 1. Similarly, the shared AP 2 may wake up the STA 2 with an ICF 2, to which the STA 2 may respond with an ICR 2. The CBF trigger frame 456 may trigger simultaneous transmission of CBF data 1 and CBF data 2.

Referring to FIGS. 4A and 4B, the shared AP's selected STA ID and MCS may be provided together with the ICF 2 because of the processing delay.

In a first user grouping scheme, no exchange of spatial compatibility is performed after channel sounding and before the initialization phase: (1) By CBF invitation, sharing AP selects its STAs and provides a candidate list of shared AP's STAs, where the candidate list may be selected based on spatial compatibility (e.g., from sharing AP's perspective). Besides the candidate list, the number of spatial streams allocated to each candidate STA may be sent. In addition, the stream allocations to the sharing AP's selected STAs may be sent. BSRP can be used as CBF invitation. (2) By CBF response, shared AP selects its STAs from the candidate list provided by the sharing AP based on buffer status, spatial compatibility from shared AP's perspective, and other factors. The selected STAs are reported to the sharing AP. Besides STA ID, the MCS of the shared AP's selected STA is reported as well. The MCSs are selected according to the stream allocations proposed by the sharing AP and the STAs chosen by both the sharing and shared APs. (3) By CBF trigger, sharing AP updates the STA list according to the shared AP's report and maybe STA capability status collected from ICR. The final STA list selected for the CBF PPDU transmission is sent to shared AP. Besides STA ID, the MCS (and maybe stream allocation) of each selected STA of the sharing AP (and maybe the shared AP) are sent as well.

For the frame exchange, it is desirable that CBF trigger has a complete list of selected STA IDs, the associated MCSs, and stream allocations like in the legacy trigger frame for UL MU-MIMO so that the APs don't need to remember what information has been sent in the previous frames. BSRP may be used as CBF trigger. In FIG. 4A, sharing AP only allocates a certain number of streams to shared AP in CBF invitation. How the allocated streams are allocated to the shared AP's selected STAs is up to the shared AP. In FIG. 4B, sharing AP allocates a certain number of streams to shared AP in CBF invitation. Besides, sharing AP specifies the number of streams of each candidate STA of the shared AP.

In some embodiments, the shared AP's selected STA ID and MCS may be provided together with the ICF 2 because of the processing delay.

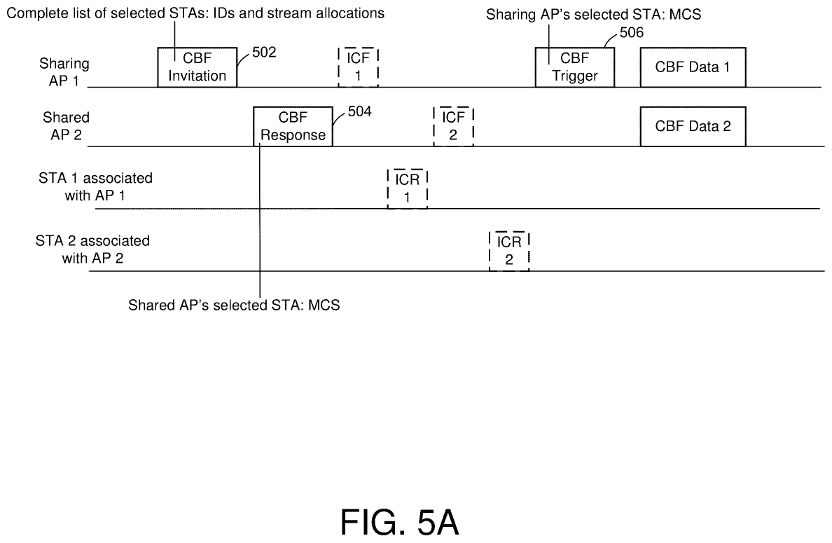

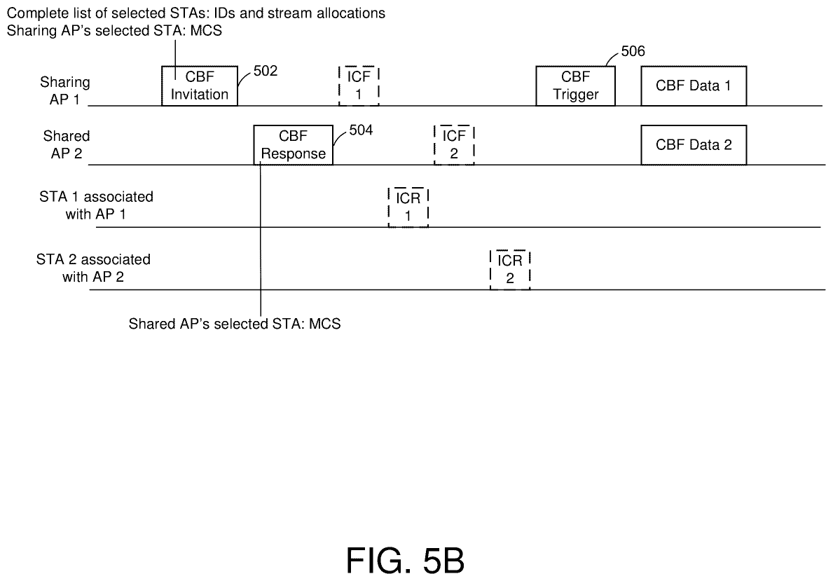

FIG. 5A shows an option in which no exchange of spatial compatibility is performed after channel sounding and before an initialization phase, in accordance with one or more example embodiments of the present disclosure.

Referring to FIG. 5A, a CBF invitation 502 sent by a sharing AP 1 may include a complete list of selected STA IDs and stream allocations (e.g., for STA 1 associated with AP 1). A CBF response 504 sent by a shared AP 2 may include the shared AP's selected STA MCS (e.g., for STA 2 associated with AP 2). When the sharing AP 1 sends a CBF trigger frame 506, it may include the sharing AP's selected STA MCS.

Optionally, the sharing AP 1 may wake up the STA 1 with an ICF 1, to which the STA 1 may respond with an ICR 1. Similarly, the shared AP 2 may wake up the STA 2 with an ICF 2, to which the STA 2 may respond with an ICR 2. The CBF trigger frame 506 may trigger simultaneous transmission of CBF data 1 and CBF data 2.

FIG. 5B shows an option in which no exchange of spatial compatibility is performed after channel sounding and before an initialization phase, in accordance with one or more example embodiments of the present disclosure.

Referring to FIG. 5B, a CBF invitation 552 sent by a sharing AP 1 may include a complete list of selected STA IDs and stream allocations and STA MCS (e.g., for STA 1 associated with AP 1). A CBF response 554 sent by a shared AP 2 may include the shared AP's selected STA MCS (e.g., for STA 2 associated with AP 2).

Optionally, the sharing AP 1 may wake up the STA 1 with an ICF 1, to which the STA 1 may respond with an ICR 1. Similarly, the shared AP 2 may wake up the STA 2 with an ICF 2, to which the STA 2 may respond with an ICR 2. A CBF trigger frame 556 may trigger simultaneous transmission of CBF data 1 and CBF data 2.

In some embodiments, the MCS of shared AP's selected STA may be provided together with the ICF 2 in FIGS. 5A and 5B because the processing delay.

In a second user grouping scheme, no exchange of spatial compatibility is performed after channel sounding and before the initialization phase. This scheme is a special case of Scheme 1, where the candidate STA list is the shortest of Scheme 1: (1) By CBF invitation, sharing AP selects its STAs and the STAs of shared AP's STAs, where the STAs of the shared AP may be selected based on spatial compatibility (e.g., from sharing AP's perspective) instead of buffer status. The stream allocations of all selected STAs and the MCSs of the sharing AP's selected STAs may be sent as well. (2) By CBF response, shared AP confirms that it accepts the STAs selected by the sharing AP based on buffer status and other factors. If CBF response just carries a confirmation, it may be just an acknowledgement frame like ACK or Multi-STA BlockAck. If the shared AP does not accept the proposal of sharing AP, the shared AP may not send the CBF response. Besides the confirmation, the MCS (and maybe stream allocation) of the shared AP selected by the sharing AP needs to be reported as well. For carrying the MCS, CBF response may be a Multi-STA BlockAck or a trigger frame like BSRP. (3) By CBF trigger, if the stream allocations of all selected STAs and the MCSs of the sharing AP's STAs were sent in Step 1), then the sharing AP just sends an acknowledgement to the shared AP. Otherwise, the sharing AP updates the STA list, stream allocation, and MCS according to the shared AP's response and maybe STA capability status collected from ICR. The final STA list, stream allocations, and MCSs selected for the CBF PPDU transmission is sent to shared AP if shared AP accepted the CBF invitation and the proposal therein. A trigger frame is desired for the CBF trigger in this case.

In a third user grouping scheme, information about spatial compatibility is acquired after channel sounding and before the initialization phase. Note that, for the optional CBF joint sounding, the exchange of beamforming/nulling vectors is not needed. For the mandatory CBF sequential sounding, the exchange is needed for checking the spatial compatibility. Besides spatial compatibility or beamforming/nulling vectors, buffer statuses and maybe MCSs of STAs may be exchanged: (1) After channel sounding (e.g., NDP sounding for CBF or ordinary beamforming), one AP (i.e., sharing AP or shared AP) may overhear the beamforming report requested by and sent to the other AP. The spec may require both APs receive all the beamforming reports of all STAs in the CBF sounding/feedback process. Or, after the CBF sounding/feedback process, the APs may exchange the beamforming and nulling vectors they received during the sounding/feedback process, e.g., using management frames. In addition, the buffer status and MCS, which is used to send data to each CBF STA, may be exchanged between the two APs using management frames. (2) By CBF invitation, sharing AP selects its STAs and the STAs of shared AP's STAs, where the STAs of the shared AP may be selected based on spatial compatibility. Stream allocations are also sent. The MCSs of sharing AP's selected STAs can be sent in CBF invitation or CBF trigger. (3) By CBF response, shared AP confirms that it accepts the STAs selected by the sharing AP based on buffer status and other factors. If CBF response just carries a confirmation, it may be just an acknowledgement frame like ACK, Multi-STA BlockAck.

Because sharing AP may not know what kind of beamforming/nulling algorithm the shared AP uses, the shared AP may send the MCSs of its selected STAs. If the shared AP does not accept the proposal of sharing AP, the shared AP may not send the CBF response. (4) By CBF trigger, sharing AP updates the STA list according to the shared AP's response and maybe STA capability status collected from ICR. The final STA list selected for the CBF PPDU transmission is sent to shared AP if shared AP accepted the CBF invitation and the proposal therein. Depending on whether full information is carried, CBF trigger can be a simple frame like Ack, RTS, and CTS, or it can be a trigger frame.

Scheme 3 is almost the same as Scheme 2 except the beamforming/nulling feedback exchange between APs and the quality of the initial user selection by the sharing AP.

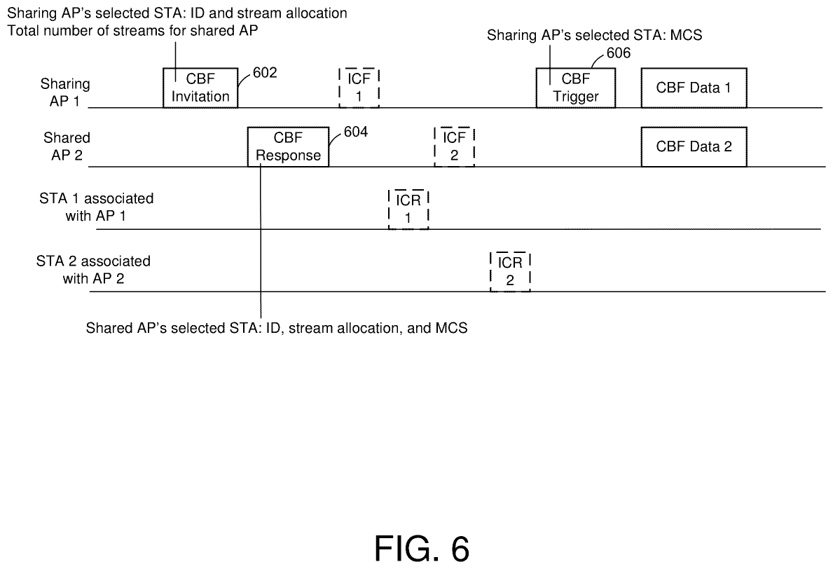

FIG. 6 shows an option for CBF signaling, in accordance with one or more example embodiments of the present disclosure.

Referring to FIG. 6, a CBF invitation 602 sent by a sharing AP 1 may include the sharing AP's selected STA IDs and stream allocations (e.g., for STA 1 associated with AP 1). A CBF response 604 sent by a shared AP 2 may include the shared AP's selected STA IDs, stream allocation, and MCS (e.g., for STA 2 associated with AP 2). When the sharing AP 1 sends a CBF trigger frame 606, it may include the sharing AP's selected STA MCS.

Optionally, the sharing AP 1 may wake up the STA 1 with an ICF 1, to which the STA 1 may respond with an ICR 1. Similarly, the shared AP 2 may wake up the STA 2 with an ICF 2, to which the STA 2 may respond with an ICR 2. The CBF trigger frame 606 may trigger simultaneous transmission of CBF data 1 and CBF data 2.

In some embodiments, the MCS of shared AP's selected STA may be provided together with the ICF 2 in FIG. 6 because of the processing delay.

In a fourth user grouping scheme, the sharing AP does not provide candidate list or select shared AP's STA. Instead, shared AP choose its STA based on spatial compatibility from both sharing and shared AP's perspectives. Information about spatial compatibility is acquired after channel sounding and before the initialization phase. Besides spatial compatibility or beamforming/nulling vectors, buffer statuses and maybe MCSs of STAs may be exchanged: (1) After channel sounding (e.g., NDP sounding for CBF or ordinary beamforming), one AP (i.e., sharing AP or shared AP) may overhear the beamforming report requested by and sent to the other AP. The spec may require both APs receive all the beamforming reports of all STAs in the CBF sounding/feedback process. Or, after the sounding/feedback process, the APs may exchange the beamforming and nulling vectors their received during the sounding/feedback process, e.g., using management frames. (2) By CBF invitation, sharing AP selects its STAs and allocates spatial streams to those STAs. The sharing AP reserve a certain number of spatial streams for the shared AP. The number of reserved streams is sent to the shared AP. BSRP frame format may be used. (3) By CBF response, shared AP selects its STAs and allocates the streams reserved by the sharing AP to the shared AP's selected STAs based on buffer status and spatial compatibility. The spec may require the shared AP to check the spatial compatibility from both sharing and shared APs' perspectives for selecting STA and allocating stream. Besides the STA IDs of shared AP's selected STAs, the stream allocation (e.g., which STA gets how many streams) and the MCS of the shared AP's selected STA are sent. Multi-STA BlockAck or BRSP frame format may be used. (4) By CBF trigger, sharing AP updates the STA list and decides MCSs of its selected STAs according to the shared AP's response and maybe STA capability status collected from ICR. For the ease of implementation, the complete, final STA IDs, stream allocations, and MCSs selected for the CBF PPDU transmission are sent to the shared AP if shared AP accepted the CBF invitation. For low overhead, the sharing AP may only send the MCSs of the sharing AP's STA. BSRP or Multi-STA BlockAck frame format may be used.

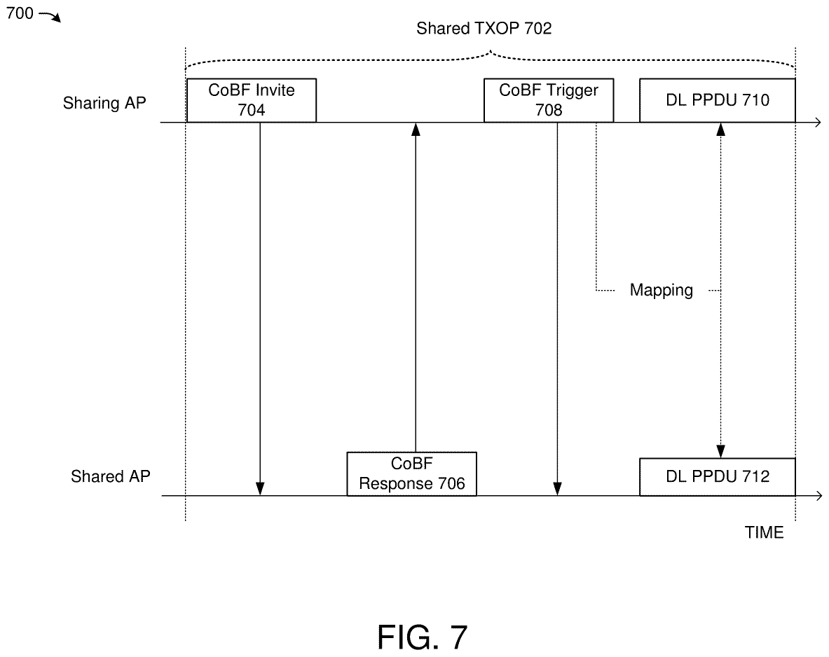

FIG. 7 shows an example sequence 700 for a downlink multi-user CoBF transmission, in accordance with one or more embodiments of the present disclosure.

Referring to FIG. 7, during a shared TXOP 702 between a sharing AP and a shared AP, the sharing AP may send a CoBF invite 704, to which the shared AP may send a CoBF response 706. The sharing AP may send a CoBF trigger frame 708 to trigger simultaneous transmissions of the sharing AP and the shared AP (e.g., DL PPDU 710 and DL PPDU 712).

In the example sequence 700 for DL MU CoBF transmission, there may be multiple main handshakes/steps. In a first step, the sharing AP may send the CoBF invite frame 704 to the shared AP with the CoBF invitation request, including the candidate or participating CoBF STA information, such as STA-ID, buffer status, number of assigned spatial streams, length, etc. In a second step, the shared AP may, based on the information shared by the sharing AP to select the candidate or participating CoBF STA with the related transmission parameters, then respond to the CoBF invitation request with confirmation (the CoBF response 706) and the candidate or participating CoBF STA information including the STA-ID, MCS, whether 2× LDPC is used or not, LDPC extra symbol segment, LDPC pre-FEC padding factor and PE Disambiguity based on Length information with the data rate, number of spatial streams and etc. In a third step, the sharing AP will analyze all the collected information and determine the final transmission parameters for the DL MU CoBF transmission, which will include: (1) Length field in the L-SIG of the DL MU PPDU, (2) Fields in the U-SIG of the DL MU PPDU as shown below in Table 15.

TABLE 15
U-SIG Format Defined for MU-PPDU in 802.1bn v0.1:

| U- | PHY | PPDU BW | UL/DL | BSS | TXOP | BSS Color 2 | | |
|---|---|---|---|---|---|---|---|---|
| SIG1 | Version | | | Color 1 | | | | |
| Field: | (set to | | | | | | | |
| | 1) | | | | | | | |
| Bits: | B0-B2 | B3-B5 | B6 | B7-B12 | B12-B19 | B20-B25 | | |
| U- | PPDU | CoBF/CoSR | Punctured | Validate | UHR- | Number | CRC | Tail |
| SIG2 | Type | | Channel | | SIG | of | | |
| Field: | | | Info | | MCS | UHR- | | |
| | | | | | | SIG | | |
| | | | | | | Symbols | | |
| U- | B0-B1 | B2 | B3-B7 | B8 | B9-B10 | B11-B15 | B16-B19 | B20-B25 |
| SIG1 | | | | | | | | |
| Field: | | | | | | | | |

The trigger frame 708 may be mapped to the L-SIG, U-SIG, and UHR-SIG fields of the DL PPDUs. The DL PPDUs may be synchronized and the data prepared for transmission.

Table 16 below shows a UHR-SIG format defined for DL MU-PPDU transmission in 802.11bn v0.1.

TABLE 16
UHR-SIG Format Defined for MU-PPDU in 802.1bn v0.1:

| Common field for | Spatial Reuse | GI + LTF | Number of | LDPC Extra | Pre-FEC |
|---|---|---|---|---|---|
| non-OFDMA | | Size | UHR-LTF | Symbol | Padding |
| transmission: | | | Symbols | Segment | Factor |
| Bits: | B0-B3 | B4-B5 | B6-B8 | B9 | B10-B11 |
| Common field for | PE | IM | Disregard | Number of non-OFDMA | |
| non-OFDMA | Disambiguity | | | Users | |
| transmission: | | | | | |
| Bits: | B12 | B13 | B14-B15 | B16-B18 | |
| User Field Format | STA-ID | MCS | Spatial | Res | |
| for MU-MIMO | | | Reconfiguration | | |
| Allocation: | | | | | |
| Bits: | B0-B10 | B11-B15 | B16-B19 | B20 | |
| User Field Format | BSS Color | | 2x LDPC | | |
| for MU-MIMO | Differentiation | | | | |
| Allocation: | | | | | |

| | | |
|---|---|---|
| Bits: | B21 | B22 |

After that, the sharing AP may carry all the determined parameters for DL MU CoBF data transmission in the CoBF-sync frame following the current defined trigger frame format in 802.11bn v0.1, which includes the UHR variant Common Info field, Special User Info field and the UHR variant User Info field as defined below in Table 17.

TABLE 17
UHR Variant Common Info Field Format (FIG. 9-90x of 802.11be):

| | | | | | | | |
|---|---|---|---|---|---|---|---|
| Field: | Trigger | UL | More | CS | UL BW | GI and | Reserved |
| | Type | Length | TF | Required | | HE/URH- | |
| | | | | | | LTF Type | |
| | | | | | | TXS Mode | |
| Bits: | B0-B3 | B4-B15 | B16 | B17 | B18-B19 | B20-B21 | B22 |
| Field: | Number | Reserved | LDPC | AP Tx | Pre- | PE | UL |
| | of | | Extra | Power | FEC | Disambiguity | Spatial |
| | HE/UHR- | | Symbol | | Padding | | Reuse |
| | LTF | | Segment | | Factor | | |
| | Symbols | | | | | | |
| Bits: | B23-B25 | B26 | B27 | B28-B33 | B34-B35 | B36 | B37-B52 |
| Field: | Reserved | HE/UHR | Special | DRU / | IFCS | UHR | Reserved |
| | | P160 | User | RRU | Present | Reserved | |
| | | | Info | Indication | Flag | | |
| | | | Field | | | | |
| | | | Flag | | | | |
| Bits: | B53 | B53 | B55 | B56-B59 | B60 | B61-B62 | B63 |

| | |
|---|---|
| Field: | Trigger Dependent Common Info |
| Bits: | Variable |

Table 18 shows an example Special User Info field format based on FIG. 9-90d of 802.11be.

TABLE 18
Special User Info Field Format (FIG. 9-90d):

| | | | | | | | |
|---|---|---|---|---|---|---|---|
| Field: | AID12 | PHY | UL BW | EHT/UHR | EHT/UHR | U-SIG | Reserved |
| | | Version | Extension | Spatial | Spatial | Disregard | |
| | | ID | | Reuse 1 | Reuse 2 | and | |
| | | | | | | Validate | |
| Bits: | B0-B11 | B12-B14 | B15-B16 | B17-B20 | B21-B24 | B25-B36 | B37-B39 |

| | |
|---|---|
| Field: | Trigger Dependent User Info |
| Bits: | Variable |

Table 19 shows an example UHR Variant User Info field format.

TABLE 19
UHR Variant User Info Field Format (FIG. 9-C):

| | | | | | | | |
|---|---|---|---|---|---|---|---|
| Field: | AID12 | RU | UL FEC | UL UHR- | 2xLD | SS | UL |
| | | Allocation | Coding | MCS | PC | Allocation | Target |
| | | | Type | | | | RX |
| | | | | | | | Power |
| Bits: | B0-B11 | B12-B19 | B20 | B21-B25 | B26 | B27-B31 | B32-B38 |

| | | |
|---|---|---|
| Field: | PS160 | Trigger Dependent User Info |
| Bits: | B39 | Variable |

Table 20 below shows the carrying information in the CoBF invite/response/sync frames according to the subfield in the L-SIG, U-SIG and UHR-SIG field of the solicited DL UHR MU PPDU with CoBF enabled.

TABLE 20
Carrying Information in CoBF Invite, Response, and Sync Frames:

| | | Carried | Carried | Carried |
|---|---|---|---|---|
| | | in CoBF | in CoBF | in CoBF |
| Subfield in CoBF data PPDU | | Invite | Response | Sync |
| L-SIG | Length (12 bits) | Yes | Yes | Yes |
| U-SIG | PHY Version Identifier (3 bits) | Yes | Yes | Yes |
| | Bandwidth (3 bits) | Yes | Yes | Yes |
| | UL/DL (1 bit) | | | |
| | BSS Color (6 bits) | | | |
| | TXOP (7 bits) | NA | NA | NA |
| | BSS Color 2(6 bits) | NA | Yes | Yes |
| | PPDU Type And Compression Mode (2 bits) | | | |
| | non-OFDMA DL MU MIMO | | | |
| | CoBF/CoSR Indication (1 bit) | Yes | Yes | Yes |
| | Punctured Channel Information (5 bits) | Yes | Yes | Yes |
| | UHR-SIG MCS (2 bits) Fix to 0 | | | |
| | Number of UHR-SIG Symbols (5 bits) | | | Yes |
| UHR-SIG | Spatial Reuse (4 bits) | | | |
| Common | (“PSR_AND_NON_SRG_OBSS_PD_PROHIBITED”) | | | |
| | GI + LTF Size (2 bits) | | | yes |
| | Number Of UHR-LTF Symbols (3 bits) | Maximum Total | Extra LTF | yes |
| | | Nss at shared AP | Allowed | |
| | | (2 bits) (QC) | (1 bit) (QC) | |
| | LDPC Extra Symbol Segment (1 bit) | Fix to 1 | Fix to 1 | Fix to 1 |
| | Pre-FEC Padding Factor (2 bits) | Fix to 4 | Fix to 4 | Fix to 4 |
| | PE Disambiguity (1 bit) | | | yes |
| | IM (Disabled) | | | |
| | Number of Non-OFDMA Users (3 bits) | | | yes |
| UHR-SIG | STA ID (11 bits) | Yes (for users | Yes (for | Yes (for |
| User | | in sharing/ | users in | users in |
| Field | | shared? | shared | both sharing/ |
| | | BSS) | BSS) | shared BSS) |
| | MCS (5 bits) | | yes | yes |
| | Spatial Configuration (4 bits) | yes | yes | yes |
| | BSS Color Indication (1 bit) | yes | yes | yes |
| | 2xLDPC (1 bit) | | yes | yes |

Some proposed details are as follows: (1) This frame which is defined as one type of trigger frame, may also be used for CoSR type I and CoSR type II transmission. So, two bits in UHR variant common info field or Special User Info field will be used to indicate whether it is for CoBF, CoSR Type I or CoSR Type II. (2) Two Bits in UHR variant common info field or in Special user Info field will be used to indicate whether it is CoBF/CoSR invite, response or sync frame. (3) One bit in UHR variant common info field or in the Special User info field will be used to indicate whether the transmitter is sync-reference or sync-follower. (4) These indication bits can be reserved bits or repurposed bits in UHR variant common info field or special user info field or even the UHR variant user info field. One example is to repurpose the second spatial reuse subfield (4 bits) in the special user info field as shown in Table 21 below. B6 in U-SIG Disregard and Validate subfield of special user info field will be used to indicate whether it is CoBF or CoSR related trigger frame, which will be useful to differentiate from normal BSRP frame if BSRP is used for the CoBF-invite/response/sync frame.

TABLE 21
Proposed Frame Format:

| B6 in U-SIG Disregard | CoBF or CoSR | The trigger | B37 in |
|---|---|---|---|
| and Validate | (B21 B22 in | frame type (B23 | Special |
| subfield of special | special user | B24 in special | User Info |
| user info field | info field) | user info field) | field |
| 0 | 0: CoBF | 0: CoBF/CoSR | 0: Sync |
| | 1: CoSR type I | invite | reference |
| | 2: CoSR type II | 1: CoBF/CoSR | 1: Sync |
| | 3: Reserved | response | follower |
| | | 2: CoBF/CoSR sync | |
| | | 3: Reserved | |
| 1 | reserved | reserved | reserved |

Tables 22 below shows how to map the subfield in the trigger frame to the related subfield in the subfield in the CoBF data PPDU.

TABLE 22
How to map the subfield in the trigger frame to the related subfield in the subfield in the CoBF data PPDU:

| Subfield in CoBF | | Subfield in | Carried in | Carried in | Carried in |
|---|---|---|---|---|---|
| data PPDU | | trigger frame | CoBF Invite | CoBF Response | CoBF Sync |
| | | CoBF/CoSR | CoBF | CoBF | CoBF |
| | | Type-I/CoSR- | | | |
| | | Type-II (2 bit) | | | |
| | | CoBF/CoSR | Invite | Response | Sync |
| | | Invite/Response/ | | | |
| | | Sync (2 bit) | | | |
| | | Sync-Reference/ | Reference/ | Follower/ | Reference/ |
| | | Sync-Follower | Follower | Reference | Follower |
| | | Indication (1 bit) | | | |
| L-SIG | Length (12 bits) | UL-LENGTH | Yes | Yes | Yes |
| | | (Common) | | | |
| U-SIG | PHY Version | PHY Version | Yes | Yes | Yes |
| | Identifier (3 bits) | Identifier | | | |
| | | (Special) | | | |
| | Bandwidth (3 bits) | UL | Yes | Yes | Yes |
| | | BW(common) + | | | |
| | | UL BW | | | |
| | | extension | | | |
| | | (Special) | | | |
| | UL/DL (1 bit) | | | | |
| | BSS Color (6 bits) | | | | |
| | TXOP (7 bits) | UL Target | NA | NA | NA |
| | | Receive power | | | |
| | | (User) | | | |
| | BSS Color 2(6 bits) | U-SIG disregard | NA | Yes | Yes |
| | | and Validate | | | |
| | | (Special) | | | |
| | PPDU Type And Compression | | | | |
| | Mode (2 bits) | | | | |
| | non-OFDMA DL MU MIMO | | | | |
| | CoBF/CoSR | U-SIG disregard | Yes | Yes | Yes |
| | Indication (1 bit) | and Validate | | | |
| | | (Special) | | | |
| | Punctured | RU Allocation | Yes | Yes | Yes |
| | Channel | (User) | | | |
| | Information (5 bits) | | | | |
| | UHR-SIG | | | | |
| | MCS (2 bits) | | | | |
| | Fix to 0 | | | | |
| | Number of | U-SIG disregard | | | Yes |
| | UHR-SIG | and Validate | | | |
| | Symbols (5 bits) | (Special) | | | |
| UHR-SIG | Spatial Reuse (4 bits) | | | | |
| Common | (“PSR_AND_NON_SRG_OBSS_PD_PROHIBITED”) | | | | |
| | GI + LTF Size (2 bits) | GI And | | | yes |
| | | HE/UHR-LTF | | | |
| | | Type/TXS mode | | | |
| | | (common) | | | |
| | Number Of | Number of | Maximum Total Nss | Extra LTF Allowed | yes |
| | UHR-LTF | HE/UHR-LTF | at shared AP | (1 bit) | |
| | Symbols (3 bits) | Symbols | (2 bits) | (QC) | |
| | | (common) | (QC) | | |
| | LDPC Extra | LDPC Extra | Fix to 1 | Fix to 1 | Fix to 1 |
| | Symbol | Symbol Segment | | | |
| | Segment (1 bit) | (common) | | | |
| | Pre-FEC | Pre-FEC | Fix to 4 | Fix to 4 | Fix to 4 |
| | Padding | padding Factor | | | |
| | Factor (2 bits) | (common) | | | |
| | PE | PE Disambiguity | | | yes |
| | Disambiguity (1 bit) | (common) | | | |
| | IM (Disabled) | | | | |
| | Number of | RU Allocation | | | yes |
| | Non-OFDMA | (User) | | | |
| | Users (3 bits) | | | | |
| UHR-SIG | STA ID (11 bits) | AID12(User) | Yes (for users | Yes (for users | Yes (for users |
| User | | | in sharing/ | in shared | in both sharing/ |
| Field | | | shared? BSS) | BSS) | shared BSS) |
| | MCS (5 bits) | MCS(User) | | yes | yes |
| | Spatial | SS | yes | yes | yes |
| | Configuration (4 bits) | Allocation(User) | | | |
| | BSS Color | Repurpose the | yes | yes | yes |
| | Indication (1 bit) | UL FEC coding | | | |
| | | type (User) | | | |
| | 2xLDPC (1 bit) | 2x LDPC | | yes | yes |

The Length field in L-SIG of DL MU CoBF PPDU may be carried in CoBF invite and sync frame, or even the CoBF response frame. It can be the UL Length subfield in UHR variant common Info field of the CoBF invite/response/sync frame.

The PHY version in U-SIG of DL MU CoBF PPDU may be carried in the PHY version Identifier in Special User Info Field of the CoBF invite/response/sync frame.

The PPDU BW in U-SIG of DL MU CoBF PPDU may be jointly indicated by the UL Bandwidth Extension subfield in the special User Info field together with the UL BW subfield in the UHR variant Common Info field in the CoBF invite/response/sync frame.

The UL/DL in U-SIG of DL MU CoBF PPDU may be fixed to be “DL”.

The BSS color 1 in-SIG of DL MU CoBF PPDU may be set to be the BSS color of the sharing AP, it may be carried in certain field in the CoBF sync frame for simplicity, such as spatial reuse subfields or reserved subfields in the special user info field of the CoBF sync frame, or reserved subfields in the UHR variant Common Info field of the CoBF sync frame.

The TXOP in U-SIG of DL MU CoBF PPDU may be fixed to be 127 or will be indicated by Repurposing the spatial reuses subfields in the Special User Info field of the CoBF invite/response/sync frame or UL Target Receive power subfields in the UHR Variant User Info field of the CoBF invite/response/sync frame as the TXOP.

The BSS color 2 in U-SIG of DL MU CoBF PPDU may be carried by the first 6 bits in the U-SIG Disregard and Validate in the Special User Info field of the CoBF invite/response/sync frame.

The PPDU type in U-SIG of DL MU CoBF PPDU may be set to be non-OFDMA DL MU MIMO for CoBF and SU for CoSR.

The CoBF/CoSR indication bit in U-SIG of DL MU CoBF PPDU may be carried in the 7th bit in the U-SIG Disregard and Validate in the Special User Info field of the CoBF invite/response/sync frame.

The Puncturing channel information (5 bits) may be carried by repurposing 5 bits in the RU Allocation subfield in UHR Variant User Info field of the CoBF invite/response/sync frame.

The UHR-SIG MCS in U-SIG of DL MU CoBF PPDU can be fixed to “0” for simplicity or be indicated by some reserved bits in the UHR variant Common Info or special User Info field of the CoBF trigger frame.

The maximum number of Nss can be added at the shared AP may be carried by the sharing AP and be carried in the last 2 bit in U-SIG Disregard and Validate subfield in Special User Info field or two reserved bits in other fields of the CoBF invite frame. whether extra LTF is allowed or not at the shared AP will be carried by the shared and be carried in the last 1 bit in U-SIG Disregard and Validate subfield in Special User Info field or one reserved bit in other fields of the CoBF response frame. The number of UHR-SIG symbols in U-SIG of DL MU CoBF PPDU will be calculated by the sharing AP and be carried in the last 5 bit in U-SIG Disregard and Validate in Special User Info field of the CoBF sync frame.

The Spatial reuse subfield in UHR-SIG common field of DL MU CoBF PPDU may be set to “PSR_AND_NON_SRG_OBSS_PD_PROHIBITED”.

The GI+LTF size in UHR-SIG common field of DL MU CoBF PPDU may be carried by the GI And HE/UHR-LTF Type/TXS mode subfield in UHR variant common Info field of the CoBF-invite/response/sync frame.

The number of UHR-LTF Symbols in UHR-SIG common field of DL MU CoBF PPDU may be carried by the Number of HE/UHR-LTF Symbols subfield in UHR variant common Info field of the CoBF-sync frame.

The LDPC extra symbol segment, Pre-FEC padding factor and PE Disambiguity subfields in UHR-SIG common field of DL MU CoBF PPDU may be carried by the LDPC extra symbol segment, Pre-FEC padding factor and PE Disambiguity subfields in UHR variant Common Info field of the CoBF-sync frame or even CoBF-invite frame.

The IM subfield in UHR-SIG common field of DL MU CoBF PPDU may be set to be “disabled” with value of “1.”

The Number of non-OFDMA users subfield in UHR-SIG common field of DL MU CoBF PPDU can be determined from the number of user info fields in the CoBF-sync frame, or it can be indicated by some reserved bits or repurposing some subfield in the UHR variant Common Info or special User Info field of the CoBF sync frame. One example is to repurpose the RU allocation subfields and use 3 bits for the number of non-OFDMA users indication.

The STA-ID in the user field of UHR SIG in DL MU CoBF PPDU can be carried by the last 11 bit of the AID12 subfield in UHR variant User Info field of the CoBF invite/response/sync frame.

The MCS in the user field of UHR SIG in DL MU CoBF PPDU can be carried by the UL UHR-MCS subfield in UHR Variant User Info field of the CoBF trigger frame.

The Spatial Configuration in the user field of UHR SIG in DL MU CoBF PPDU can be carried by the SS Allocation subfield in UHR Variant User Info field of the CoBF sync frame. The spatial configuration for the users with sharing AP or shared AP will be carried by the SS Allocation subfield in the UHR variant user field for the STAs in sharing AP or shared AP of the CoBF invite frame. The spatial configuration for the users with shared AP will be carried by the SS Allocation subfield in the UHR variant user field for the STAs in shared AP of the CoBF response frame.

The BSS color differentiation in the user field of UHR SIG in DL MU CoBF PPDU, which is used to indicate which BSS the related STAID belongs to, will be carried by repurposing the UL FEC coding type subfield in UHR Variant User Info field of the CoBF trigger frame.

The 2× LDPC in the user field of UHR SIG in DL MU CoBF PPDU can be carried by the 2× LDPC subfield in UHR Variant User Info field of the Trigger frame.

The CoBF invite frame may only include the user information for sharing AP with only STA ID and number of spatial stream information. It may also include the candidate user information for shared AP. The CoBF response frame will include the user information for shared AP with detail user information including MCS, number of spatial streams, 2× LDPC and etc. The CoBF sync frame will include the user information for both sharing AP and shared AP with detail per user information including MCS, number of spatial steams, 2× LDPC, BSS color differentiation and etc.

The CoBF-invite/response/sync frame may be a unicast frame with the shared/sharing AP's MAC address as the RA. It may be defined based on current basic or BSRP trigger frame with some minor change, or be defined as new trigger type, which will be indicated by one of the reserved values between 9-15. The trigger frame design can also be applied in the CoSR-trigger frame.

Alternatively, the CoBF response can be carried in a Multi-STA BA frame (instead of carrying it in a Trigger frame, in response to the CoBF Invite). In that case, the Multi-STA BA will be Unicasted to the AP that sent the CoBF Invite (meaning the RA field will be set to the address of the AP that sent the CoBF invite).

There are a few options for the signaling. First option: include all feedbacks in a single Per AID TID Info field. The M-STA BA includes a special Per AID TID Info field that is identified to carry feedback: Reuse the generic feedback Per AID TID Info field container to carry that information: The per AID TID Info field is identified by setting the Ack Type field to 0 and the TID field to 13 so that the Per AID TID Info field is as in FIG. 9-60a and includes a Feedback field instead of a BlockAck Bitmap field. The Feedback field is made of one or more Per Feedback fields that start with a Feedback Type field and a Feedback Length field and a Feedback content field. The Feedback Type field is set to a value that indicates CoBF Response feedback.

When that value is included in the Feedback type, the Feedback content may include all the fields that are needed for CoBF response as follows: STA1 AID, STA1 NSS, STA1 MCS, STA1 2×LDPC, STA2 AID (can be set to a special value if there is no STA 2), STA2 NSS, STA2 MCS, STA2 2×LDPC.

Second option: include feedback in one or two Per AID TID Info field (one Per AID TID Info field for each scheduled STA). The M-STA BA includes one or two special Per AID TID Info field that is identified to carry feedback: Reuse the generic feedback Per AID TID Info field container to carry that information: The per AID TID Info field is identified by setting the Ack Type field to 0 and the TID field to 13 so that the Per AID TID Info field is as in FIG. 9-60a and includes a Feedback field instead of a BlockAck Bitmap field. The AID 11 field is set to the AID of the STA that will be scheduled for CoBF. If the AP schedules two STAs, then there will be two Per AID TID Info fields, one for each STA. The Feedback field is made of one or more Per Feedback fields that start with a Feedback Type field and a Feedback Length field and a Feedback content field. The Feedback Type field is set to a value that indicates CoBF Response feedback. When that value is included in the Feedback type, the feedback content includes all the fields that are needed for CoBF response as follows: NSS, MCS, 2×LDPC.

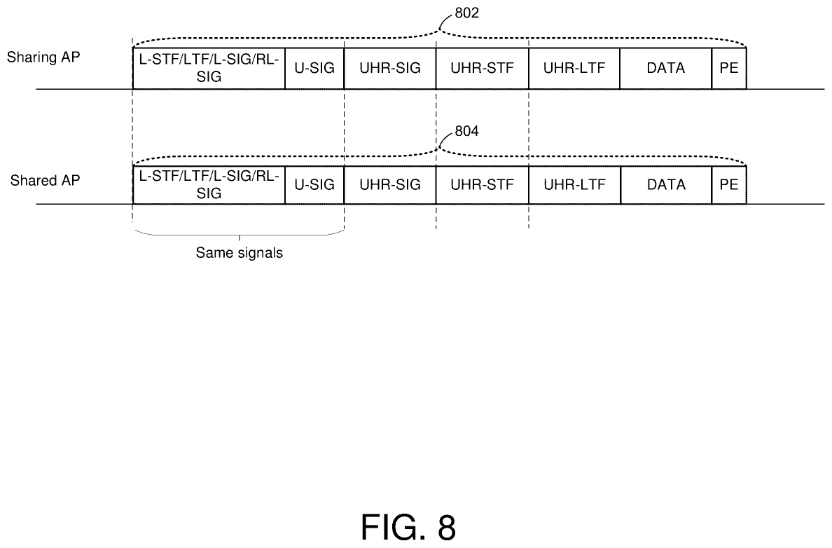

FIG. 8 shows an example CSR mode, in accordance with one or more embodiments of the present disclosure.

Referring to FIG. 8, a sharing AP and a shared AP each may send data PPDUs (data PPDU 802, data PPDU 804) with the same pre-UHR preamble, which consists of L-STF/L-LTF/L-SIG/RL-SIG/U-SIG. The data PPDUs also include a UHR-STF, UHR-LTF, the data, and a packet extension (PE). Because the number of UHR-SIG symbols is specified in the U-SIG and the U-SIG contents and signals of the two APs are the same, the number of UHR-SIG symbols are the same. Furthermore, the duration of the UHR-STF is the same for all the APs. As a result, the APs start the UHR-LTF at the same time.

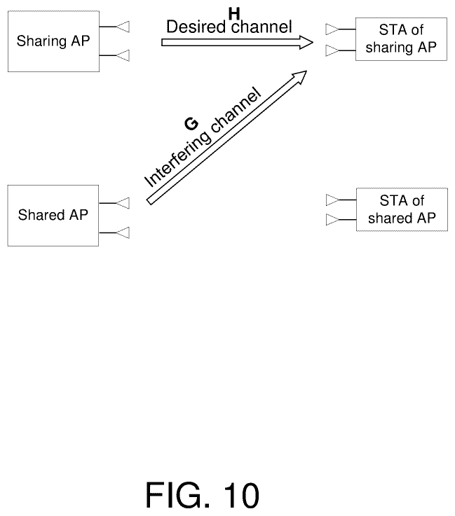

This causes a problem. The channel training symbols, which are the UHR-LTF symbols sent by the APs, are the same or partially the same when the number of spatial streams of each AP is picked from 1, 2, 3, 4, 7, and 8. Because the training symbols are the same or partially the same, the intended STA cannot distinguish the desired channel from the interfering channel. Instead, the estimated channel is an aggregation of the desired and interfering channels as illustrated in FIGS. 9 and 10 and Equation (2).

FIG. 9 shows an example of CoBF for STAs with multiple antennas, in accordance with one or more embodiments of the present disclosure.

In FIG. 9, even though each STA has multiple antennas, which can mitigate fully or partially the interference from the other AP, the interference cannot be mitigated because each STA does not know the desired and interfering channels, respectively.

FIG. 10 shows an example of how the availability of a desired channel and interfering channel improve performance even if there are no additional antennas at an STA, in accordance with one or more embodiments of the present disclosure.

FIG. 10 illustrates that the availability of the desired channel and interfering channel improve the performance even if there are no additional antennas at the STA. Denote the channel matrix of the desired link from sharing AP to its STA by H. Denote the channel matrix of the interfering link from the shared AP to the STA of the sharing AP by G. The ideal linear MMSE receiver of the STA of the sharing AP is given by Equation (1) above.

With the knowledge of the covariance matrix, the STA can suppress the strong interference from a certain direction(s). Besides, the log-likelihood ratios (LLRs) of the demodulated codebits can be calculated accurately such that the LDPC decoding doesn't degrade. In contrast, without the knowledge of the covariance matrix, the STA can't suppress the interference using the spatial structure of the interference and can't calculate the LLRs accurately. The mismatched MMSE receiver of the existing scheme is given by Equation (2) above.

As a result, the STA tries to demodulate the summation of the data symbols from the two APs instead of the data symbols from its AP. For non-linear receivers like sphere decoder, the covariance matrix of interference plus noise, i.e., G*G+σ²l, also needs to be known. For the existing scheme, the covariance matrix is estimated as σ²l, which results into performance degradation. The examples in FIGS. 9 and 10 illustrate the problem at the STA of the sharing AP. The problem is the same at the STA of the shared AP due to symmetry. In the case that the STA has additional antennas, which can be used for mitigating the interference, the unavailability of the interfering channel knowledge prevents the interference mitigation.

There is another mode of CSR. In this mode, one AP transmits UHR PPDU while the other AP transmits EHT PPDU simultaneously. As an alternative, both APs transmit EHT PPDUs simultaneously. The problem illustrated in FIGS. 2 2 and 3 also exists in the UHR+EHE and EHT+EHT modes as follows. The long training fields (LTFs) like EHT-LTF and UHR-LTF can be fully or partially aligned with each other. When they are fully aligned, the same problem as FIG. 1 occurs. When the LTFs of the two PPDUs are offset by one or two OFDM symbols, the problem remains partially because the LTF symbol sequences, i.e., the P-matrix codes, have a cyclic shift structure.

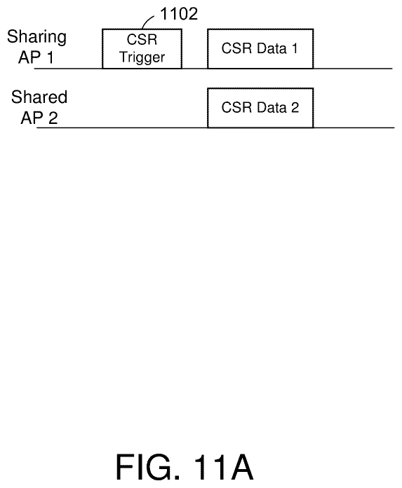

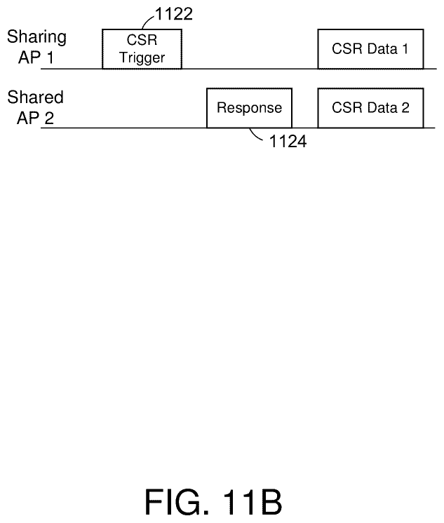

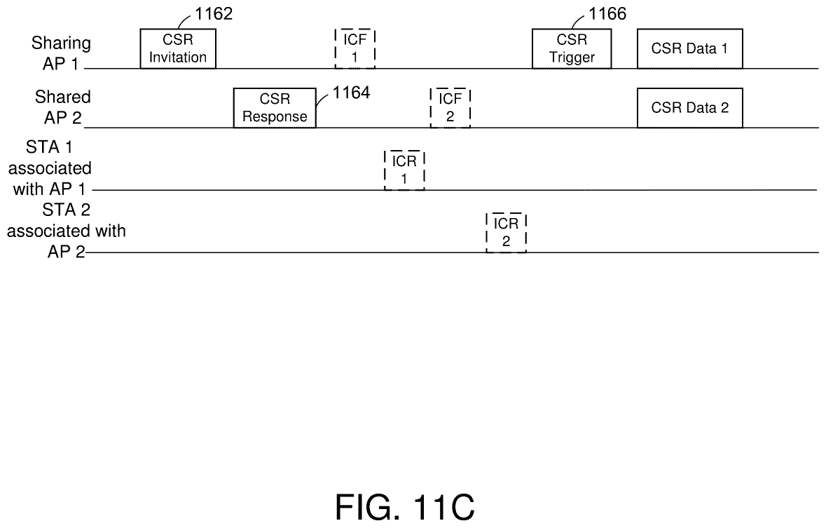

FIG. 11A shows an example frame exchange sequence for CSR, in accordance with one or more embodiments of the present disclosure.

Referring to FIG. 11A, a sharing AP 1 may send a CSR trigger frame 1102 to trigger simultaneous CSR data transmissions from the sharing AP 1 and a shared AP 2 (e.g., CSR data 1, CSR data 2).

FIG. 11B shows an example frame exchange sequence for CSR, in accordance with one or more embodiments of the present disclosure.

Referring to FIG. 11B, a sharing AP 1 may send a CSR trigger frame 1122 to trigger simultaneous CSR data transmissions from the sharing AP 1 and a shared AP 2 (e.g., CSR data 1, CSR data 2). In response to the CSR trigger frame 1122, the shared AP 2 may send a response 1124 to confirm the invitation.

FIG. 11C shows an example frame exchange sequence for CSR, in accordance with one or more embodiments of the present disclosure.

Referring to FIG. 11C, a sharing AP 1 may send a CSR invitation 1162 to invite a shared AP 2 to shared transmissions, and the shared AP 2 may respond with a CSR response 1164. Optionally, the sharing AP 1 and the shared AP 2 may wake up their associated STAs (e.g., with an ICF 1 to STA 1 associated with AP 1, to which the STA 1 may respond with an ICR 1, and with an ICF 2 to STA 2 associated with AP 2, to which the STA 1 may respond with an ICR 2). Then, the sharing AP 1 may send a CSR trigger frame 1166 to trigger the simultaneous transmissions (CSR data 1, CSR data 2) of the sharing AP 1 and the shared AP 2.

Referring to FIGS. 11A-11C, the frame exchange sequences of CSR and CBF can be unified. For example, the same frame type can be used for triggering CSR and CBF and an indication within the trigger frame indicates which mode of CSR and CBF is triggered. The CSR invitation (or CSR invite or CSR initiation) and CSR response can be ICF and ICR frames addressed to AP instead of STA.

For the EHT PPDU, one feedback about using UHR MU-MIMO PPDU for CSR is that some users want to use UHR SU PPDU for CSR. The present disclosure addresses this comment by using EHT MU-PPDU instead of UHR MU-PPDU. Because the performances of EHT PPDU and UHR PPDU are similar, instead of UHR+UHR, it is helpful using EHT+EHT to address users' concerns. In the EHT+EHT, the EHT PPDU can be MU-MIMO PPDU or SU PPDU. It is possible to reuse stream allocation methods for allocating spatial streams in EHT+EHT. The PPDU types of the APs may be specified and exchanged before the CSR PPDU, e.g., in CSR trigger, CSR invitation, CSR response, ICF/ICR, or during the CSR negotiation.

For a SU PPDU with additional LTF symbols, in EHT, for enhancing the channel estimation at the receiver, the transmitter can use more LTF symbols than the normal or legacy as shown in Table 23 below (representing Table 36-43 of 802.11be) and the subsequent paragraph.

TABLE 23
Initial Number of EHT-LTFs required for different
number of spatial streams (Table 36-43):

| NSS | Initial NEHT-LTF |
|---|---|
| 1 | 1 |
| 2 | 2 |
| 3-4 | 4 |
| 5-6 | 6 |
| 7-8 | 8 |

In order to improve the MIMO channel estimation for the reception of non-OFDMA EHT MU PPDU or EHT sounding NDP, the number of EHT-LTFs may be larger than the initial number of EHT-LTFs determined by the total number of spatial streams. If additional EHT-LTFs are used, then the total number of EHT-LTFs (which is signaled separately from Nss) shall be no more than twice the initial number of EHT-LTFs determined by the number of spatial streams as shown in Table 36-43 (Initial number of EHT-LTFs required for different number of spatial streams), and chosen from the set {2 4 8}. Supporting additional EHT-LTFs is optional for the receiver, which is indicated by the Maximum Number of Supported EHT-LTFs subfield of the EHT PHY Capabilities Information field.

This feature may be carried on in UHR and can use the additional LTF symbols for estimating the interfering channel.

For a mix of SU PPDU and MU PPDU, for UHR+EHT, the UHR PPDU can be SU PPDU with additional LTF symbols as described in the previous subclause. Because the present disclosure may use UHR SUPPDU for CSR, the concern from users above is addressed. The EHT PPDU can be MU-MIMO PPDU. For example, the UHR PPDU has 2 streams and the EHT PPDU has 1 stream, respectively. UHR PPDU type is set to SU PPDU with 4 LTF symbols. EHT PPDU type is set to MU-MIMO PPDU with two users, one fake user and one real user. The fake user has 2 streams and the real user has 1 stream, respectively. No LTF and data signals are actually sent for the fake user. The EHT PPDU has 4 LTF symbols. In addition, the total number of OFDM symbols for the SIG fields of both APs are set to be the same so that start time of the LTF symbols for both PPDUs are aligned. The number of SIG field symbols and/or the PPDU types of the APs may be specified and exchanged before the CSR PPDU, e.g., in CSR trigger, CSR invitation, CSR response, ICF/ICR, or during the CSR negotiation. This method can be generalized to UHR+UHR if one of the UHR PPDUs can be a MU-PPDU.

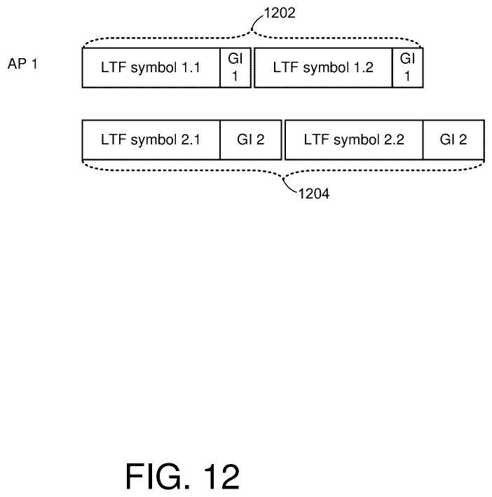

FIG. 12 shows an example of using different guard interval (GI) durations for CSR PPDUs, in accordance with one or more embodiments of the present disclosure.

Referring to FIG. 12, an AP 1 may send a CSR PPDU 1202 and an AP 2 may send a CSR PPDU 1204. The CSR PPDU 1202 may include an LTF symbol 1.1, a GI1, an LTF symbol 1.2, and a GI1. The CSR PPDU 124 may include an LTF symbol 2.1, a GI2, an LTF symbol 2.2, and a GI2. GI1 and GI2 may be of different lengths.

For different GI durations, instead of enabling the estimation of both desired and interfering channels, it may be beneficial to estimate the desired channel of one AP in the presence of the other AP's interference. Although the performance is not as good as estimating both channels, it requires fewer LTF symbols than the optimal solution. The key is to prevent the alignment of the LTFs of the two CSR PPDUs. Different GIs or CPs, e.g., 0.8 microsecond and 1.6 microseconds, can be used by different APs, respectively so that the LTF symbol boundaries are not fully aligned. The GI or CP durations may be specified and exchanged before the CSR PPDU, e.g., in CSR trigger, CSR invitation, CSR response, ICF/ICR, or during the CSR negotiation.

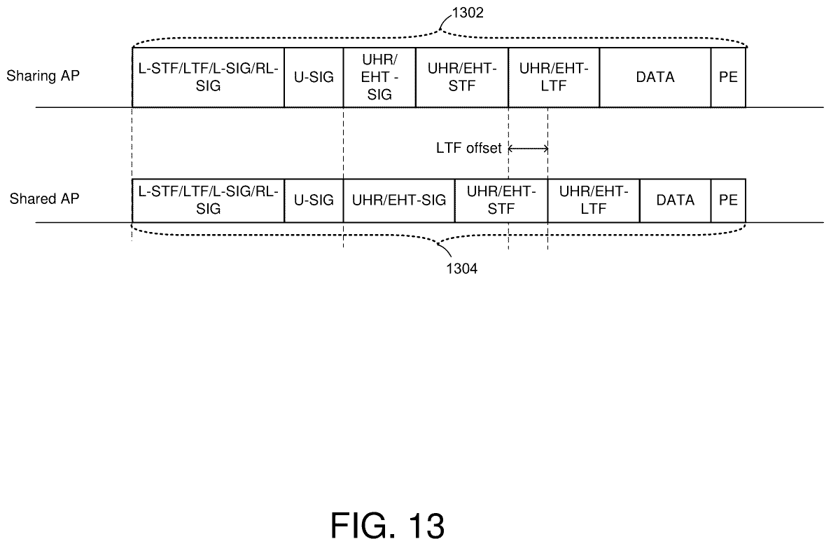

FIG. 13 shows an example use of an offset to estimate a desired channel of one AP in the presence of another AP's interference, in accordance with one or more embodiments of the present disclosure.

Referring to FIG. 13, a sharing AP may send a CSR PPDU 1302, and a shared AP may send a CSR PPDU 1304, each including a legacy preamble (L-STF, LTF, L-SIG, RL-SIG), a UHR/EHT-SIG, a UHR/EHT-STF, a UHR/EHT-LTF, data, and a PE.

For different LTF start times, instead of enabling the estimation of both desired and interfering channels, it may be beneficial to estimate the desired channel of one AP in the presence of the other AP's interference. Although the performance is not as good as estimating both channels, it requires fewer LTF symbols than the optimal solution. The key is to prevent the alignment of the LTFs of the two APs. To create an offset between the two LTFs, which are two LTF symbol sequences, the UHR-(or EHT-) SIG fields of the two CSR PPDUs can have different durations. For example, the number of OFDM symbols for the shared AP's UHR/EHT-SIG can be greater than that of sharing AP. The number of OFDM symbols of one or both APs may be specified and exchanged before the CSR PPDU, e.g., in CSR trigger, CSR invitation, CSR response, ICF/ICR, or during the CSR negotiation.

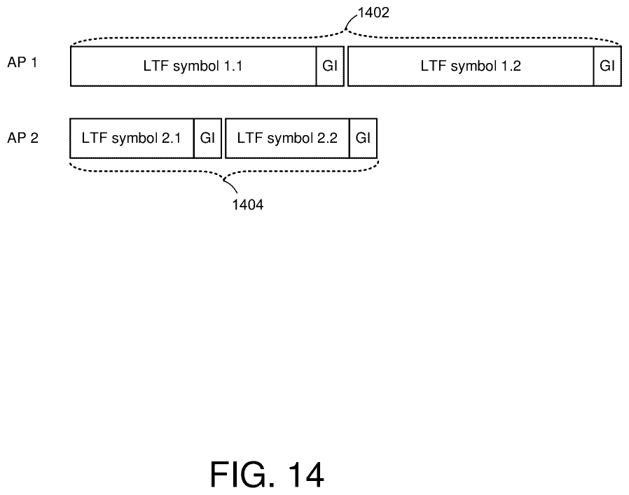

FIG. 14 shows an example of CSR PPDUs with different LTF symbol durations, in accordance with one or more embodiments of the present disclosure.

Referring to FIG. 14, an AP 1 may send a CSR PPDU 1402 with an LTF symbol 1.1, a GI, an LTF symbol 1.2, and a GI. An AP 2 may send a CSR PPDU 1404 with an LTF symbol 2.1, a GI, and LTF symbol 2.2, and a GI.

For different LTF symbol durations, instead of enabling the estimation of both desired and interfering channels, it may be beneficial to estimate the desired channel of one AP in the presence of the other AP's interference. Although the performance is not as good as estimating both channels, it requires fewer LTF symbols than the optimal solution. The key is to use different LTF symbol durations, e.g., 1× LTF symbol duration and 2× LTF symbol duration, for different APs, respectively. The LTF symbol duration of one or both APs may be specified and exchanged before the CSR PPDU, e.g., in CSR trigger, CSR invitation, CSR response, ICF/ICR, or during the CSR negotiation.

For different PPDU start times, instead of enabling the estimation of both desired and interfering channels, one may just want to estimate the desired channel of one AP in the presence of the other AP's interference. Although the performance is not as good as estimating of both channels, it requires fewer LTF symbols than the optimal solution. The key is to prevent the alignment of the LTFs of the two CSR PPDUs. Some solutions herein make the UHR-(or EHT-) LTFs not aligned. However, the L-LTFs of the legacy preambles can still be aligned. In this solution, we may let the start times of the two CSR PPDU different such that the intended LTFs are not aligned in time. The time offset may be defined in the spec. Or, the time offset may be specified and exchanged before the CSR PPDU, e.g., in CSR trigger, CSR invitation, CSR response, ICF/ICR, or during the CSR negotiation.

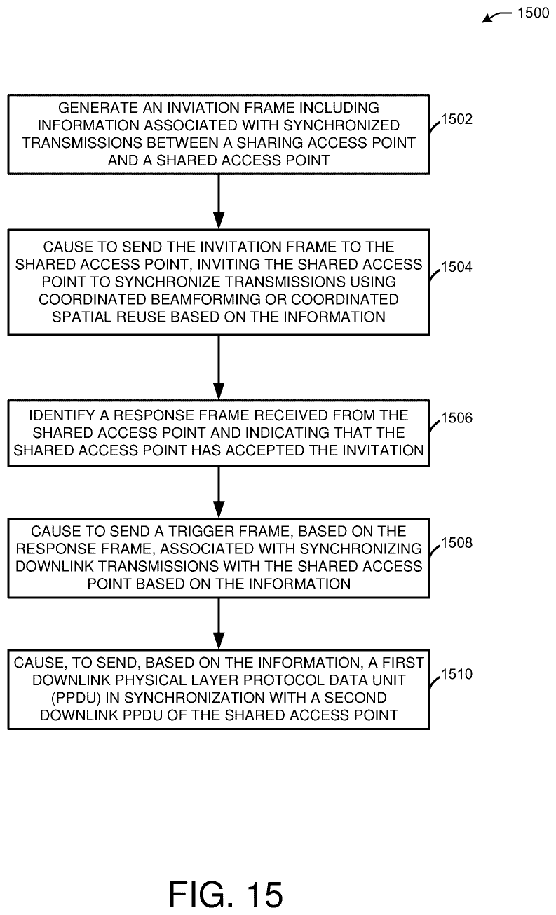

FIG. 15 illustrates a flow diagram of illustrative process 1500 for an enhanced multi-AP coordinated beamforming and coordinated spatial reuse, in accordance with one or more example embodiments of the present disclosure.

At block 1502, a device (e.g., the AP 102 of FIG. 1, the sharing AP of FIG. 2, and/or the enhanced CBF/CSR device 1719 of FIG. 17) may generate an invitation frame (e.g., the CBF/CSR invitation 204) including information associated with synchronized transmissions between the device and a shared AP (e.g., the shared AP of FIG. 2). The information may include a minimum number of data orthogonal frequency division multiplex (OFDM) symbols of the synchronized transmissions, a minimum number of data OFDM symbols of the synchronized transmissions, a physical layer (PHY) version of the synchronized transmissions, a bandwidth used by the synchronized transmissions, a puncturing pattern of the synchronized transmissions, a guard interval and long training field size of the synchronized transmissions, a maximum total number of spatial streams allowed for the second downlink PPDU, a number of recipient station devices (STAs) of the synchronized transmissions that are associated with the device, an STA identifier of each of the recipient STAs, a number of spatial streams for each recipient STA associated with the device, an indication that an exchange of an initial control frame and an initial control response between the device and any STAs to receive the first downlink PPDU is to precede the first downlink PPDU, a duration of the exchange, and/or an indication that the downlink transmissions are to use a first type of coordinated beamforming or spatial reuse, or a second type of spatial reuse.

At block 1504, the device may cause to send the invitation frame to the shared AP, the invitation frame inviting the shared AP to synchronize transmissions with the device using coordinated beamforming or coordinated spatial reuse based on the information.

At block 1506, the device may identify a response frame (e.g., the CBF/CSR response 206 of FIG. 2) received from the shared AP and indicating that the shared AP has accepted the invitation to coordinate transmissions with the device based on the information.

At block 1508, the device may cause to send a trigger frame (e.g., the CBF/CSR trigger frame 208), based on the response frame, associated with synchronizing downlink transmissions with the shared AP based on the information.

At block 1510, the device may cause to send, based on the information, a first downlink physical layer protocol data unit (PPDU) in synchronization with a second downlink PPDU of the shared AP (e.g., the CBF/CSR data 1 and data 2 PPDUs of FIG. 2).

It is understood that the above descriptions are for the purposes of illustration and are not meant to be limiting.

FIG. 16 shows a functional diagram of an exemplary communication station 300, in accordance with one or more example embodiments of the present disclosure. In one embodiment, FIG. 16 illustrates a functional block diagram of a communication station that may be suitable for use as an AP 102 (FIG. 1) or a user device 120 (FIG. 1) in accordance with some embodiments. The communication station 1600 may also be suitable for use as a handheld device, a mobile device, a cellular telephone, a smartphone, a tablet, a netbook, a wireless terminal, a laptop computer, a wearable computer device, a femtocell, a high data rate (HDR) subscriber station, an access point, an access terminal, or other personal communication system (PCS) device.

The communication station 1600 may include communications circuitry 1602 and a transceiver 1610 for transmitting and receiving signals to and from other communication stations using one or more antennas 1601. The communications circuitry 1602 may include circuitry that can operate the physical layer (PHY) communications and/or medium access control (MAC) communications for controlling access to the wireless medium, and/or any other communications layers for transmitting and receiving signals. The communication station 1600 may also include processing circuitry 1606 and memory 1608 arranged to perform the operations described herein. In some embodiments, the communications circuitry 1602 and the processing circuitry 1606 may be configured to perform operations detailed in the above figures, diagrams, and flows.

In accordance with some embodiments, the communications circuitry 1602 may be arranged to contend for a wireless medium and configure frames or packets for communicating over the wireless medium. The communications circuitry 1602 may be arranged to transmit and receive signals. The communications circuitry 1602 may also include circuitry for modulation/demodulation, upconversion/downconversion, filtering, amplification, etc. In some embodiments, the processing circuitry 1606 of the communication station 1600 may include one or more processors. In other embodiments, two or more antennas 1601 may be coupled to the communications circuitry 1602 arranged for sending and receiving signals. The memory 1608 may store information for configuring the processing circuitry 1606 to perform operations for configuring and transmitting message frames and performing the various operations described herein. The memory 1608 may include any type of memory, including non-transitory memory, for storing information in a form readable by a machine (e.g., a computer). For example, the memory 1608 may include a computer-readable storage device, read-only memory (ROM), random-access memory (RAM), magnetic disk storage media, optical storage media, flash-memory devices and other storage devices and media.

In some embodiments, the communication station 1600 may be part of a portable wireless communication device, such as a personal digital assistant (PDA), a laptop or portable computer with wireless communication capability, a web tablet, a wireless telephone, a smartphone, a wireless headset, a pager, an instant messaging device, a digital camera, an access point, a television, a medical device (e.g., a heart rate monitor, a blood pressure monitor, etc.), a wearable computer device, or another device that may receive and/or transmit information wirelessly.

In some embodiments, the communication station 1600 may include one or more antennas 1601. The antennas 1601 may include one or more directional or omnidirectional antennas, including, for example, dipole antennas, monopole antennas, patch antennas, loop antennas, microstrip antennas, or other types of antennas suitable for transmission of RF signals. In some embodiments, instead of two or more antennas, a single antenna with multiple apertures may be used. In these embodiments, each aperture may be considered a separate antenna. In some multiple-input multiple-output (MIMO) embodiments, the antennas may be effectively separated for spatial diversity and the different channel characteristics that may result between each of the antennas and the antennas of a transmitting station.

In some embodiments, the communication station 1600 may include one or more of a keyboard, a display, a non-volatile memory port, multiple antennas, a graphics processor, an application processor, speakers, and other mobile device elements. The display may be an LCD screen including a touch screen.

Although the communication station 1600 is illustrated as having several separate functional elements, two or more of the functional elements may be combined and may be implemented by combinations of software-configured elements, such as processing elements including digital signal processors (DSPs), and/or other hardware elements. For example, some elements may include one or more microprocessors, DSPs, field-programmable gate arrays (FPGAs), application specific integrated circuits (ASICs), radio-frequency integrated circuits (RFICs) and combinations of various hardware and logic circuitry for performing at least the functions described herein. In some embodiments, the functional elements of the communication station 1600 may refer to one or more processes operating on one or more processing elements.

Certain embodiments may be implemented in one or a combination of hardware, firmware, and software. Other embodiments may also be implemented as instructions stored on a computer-readable storage device, which may be read and executed by at least one processor to perform the operations described herein. A computer-readable storage device may include any non-transitory memory mechanism for storing information in a form readable by a machine (e.g., a computer). For example, a computer-readable storage device may include read-only memory (ROM), random-access memory (RAM), magnetic disk storage media, optical storage media, flash-memory devices, and other storage devices and media. In some embodiments, the communication station 300 may include one or more processors and may be configured with instructions stored on a computer-readable storage device.

FIG. 17 illustrates a block diagram of an example of a machine 1700 or system upon which any one or more of the techniques (e.g., methodologies) discussed herein may be performed. In other embodiments, the machine 1700 may operate as a standalone device or may be connected (e.g., networked) to other machines. In a networked deployment, the machine 1700 may operate in the capacity of a server machine, a client machine, or both in server-client network environments. In an example, the machine 1700 may act as a peer machine in peer-to-peer (P2P) (or other distributed) network environments. The machine 1700 may be a personal computer (PC), a tablet PC, a set-top box (STB), a personal digital assistant (PDA), a mobile telephone, a wearable computer device, a web appliance, a network router, a switch or bridge, or any machine capable of executing instructions (sequential or otherwise) that specify actions to be taken by that machine, such as a base station. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), or other computer cluster configurations.

Examples, as described herein, may include or may operate on logic or a number of components, modules, or mechanisms. Modules are tangible entities (e.g., hardware) capable of performing specified operations when operating. A module includes hardware. In an example, the hardware may be specifically configured to carry out a specific operation (e.g., hardwired). In another example, the hardware may include configurable execution units (e.g., transistors, circuits, etc.) and a computer readable medium containing instructions where the instructions configure the execution units to carry out a specific operation when in operation. The configuring may occur under the direction of the executions units or a loading mechanism. Accordingly, the execution units are communicatively coupled to the computer-readable medium when the device is operating. In this example, the execution units may be a member of more than one module. For example, under operation, the execution units may be configured by a first set of instructions to implement a first module at one point in time and reconfigured by a second set of instructions to implement a second module at a second point in time.

The machine (e.g., computer system) 1700 may include a hardware processor 1702 (e.g., a central processing unit (CPU), a graphics processing unit (GPU), a hardware processor core, or any combination thereof), a main memory 1704 and a static memory 1706, some or all of which may communicate with each other via an interlink (e.g., bus) 1708. The machine 1700 may further include a power management device 1732, a graphics display device 1710, an alphanumeric input device 1712 (e.g., a keyboard), and a user interface (UI) navigation device 1714 (e.g., a mouse). In an example, the graphics display device 1710, alphanumeric input device 1712, and UI navigation device 1714 may be a touch screen display. The machine 1700 may additionally include a storage device (i.e., drive unit) 1716, a signal generation device 1718 (e.g., a speaker), an enhanced CBF/CSR device 1719, a network interface device/transceiver 1720 coupled to antenna(s) 1730, and one or more sensors 1728, such as a global positioning system (GPS) sensor, a compass, an accelerometer, or other sensor. The machine 1700 may include an output controller 1734, such as a serial (e.g., universal serial bus (USB), parallel, or other wired or wireless (e.g., infrared (IR), near field communication (NFC), etc.) connection to communicate with or control one or more peripheral devices (e.g., a printer, a card reader, etc.)). The operations in accordance with one or more example embodiments of the present disclosure may be carried out by a baseband processor. The baseband processor may be configured to generate corresponding baseband signals. The baseband processor may further include physical layer (PHY) and medium access control layer (MAC) circuitry, and may further interface with the hardware processor 1702 for generation and processing of the baseband signals and for controlling operations of the main memory 1704, the storage device 1716, and/or the enhanced CBF/CSR device 1719. The baseband processor may be provided on a single radio card, a single chip, or an integrated circuit (IC).

The storage device 1716 may include a machine readable medium 1722 on which is stored one or more sets of data structures or instructions 1724 (e.g., software) embodying or utilized by any one or more of the techniques or functions described herein. The instructions 1724 may also reside, completely or at least partially, within the main memory 1704, within the static memory 1706, or within the hardware processor 1702 during execution thereof by the machine 1700. In an example, one or any combination of the hardware processor 1702, the main memory 1704, the static memory 1706, or the storage device 1716 may constitute machine-readable media.

The enhanced CBF/CSR device 1719 may carry out or perform any of the operations and processes (e.g., process 1500) described and shown above.

It is understood that the above are only a subset of what the enhanced CBF/CSR device 1719 may be configured to perform and that other functions included throughout this disclosure may also be performed by the enhanced CBF/CSR device 1719.

While the machine-readable medium 1722 is illustrated as a single medium, the term “machine-readable medium” may include a single medium or multiple media (e.g., a centralized or distributed database, and/or associated caches and servers) configured to store the one or more instructions 1724.

Various embodiments may be implemented fully or partially in software and/or firmware. This software and/or firmware may take the form of instructions contained in or on a non-transitory computer-readable storage medium. Those instructions may then be read and executed by one or more processors to enable performance of the operations described herein. The instructions may be in any suitable form, such as but not limited to source code, compiled code, interpreted code, executable code, static code, dynamic code, and the like. Such a computer-readable medium may include any tangible non-transitory medium for storing information in a form readable by one or more computers, such as but not limited to read only memory (ROM); random access memory (RAM); magnetic disk storage media; optical storage media; a flash memory, etc.

The term “machine-readable medium” may include any medium that is capable of storing, encoding, or carrying instructions for execution by the machine 1700 and that cause the machine 1700 to perform any one or more of the techniques of the present disclosure, or that is capable of storing, encoding, or carrying data structures used by or associated with such instructions. Non-limiting machine-readable medium examples may include solid-state memories and optical and magnetic media. In an example, a massed machine-readable medium includes a machine-readable medium with a plurality of particles having resting mass. Specific examples of massed machine-readable media may include non-volatile memory, such as semiconductor memory devices (e.g., electrically programmable read-only memory (EPROM), or electrically erasable programmable read-only memory (EEPROM)) and flash memory devices; magnetic disks, such as internal hard disks and removable disks; magneto-optical disks; and CD-ROM and DVD-ROM disks.

The instructions 1724 may further be transmitted or received over a communications network 1726 using a transmission medium via the network interface device/transceiver 1720 utilizing any one of a number of transfer protocols (e.g., frame relay, internet protocol (IP), transmission control protocol (TCP), user datagram protocol (UDP), hypertext transfer protocol (HTTP), etc.). Example communications networks may include a local area network (LAN), a wide area network (WAN), a packet data network (e.g., the Internet), mobile telephone networks (e.g., cellular networks), plain old telephone (POTS) networks, wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, and peer-to-peer (P2P) networks, among others. In an example, the network interface device/transceiver 1720 may include one or more physical jacks (e.g., Ethernet, coaxial, or phone jacks) or one or more antennas to connect to the communications network 1726. In an example, the network interface device/transceiver 1720 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding, or carrying instructions for execution by the machine 1700 and includes digital or analog communications signals or other intangible media to facilitate communication of such software.

The operations and processes described and shown above may be carried out or performed in any suitable order as desired in various implementations. Additionally, in certain implementations, at least a portion of the operations may be carried out in parallel. Furthermore, in certain implementations, less than or more than the operations described may be performed.

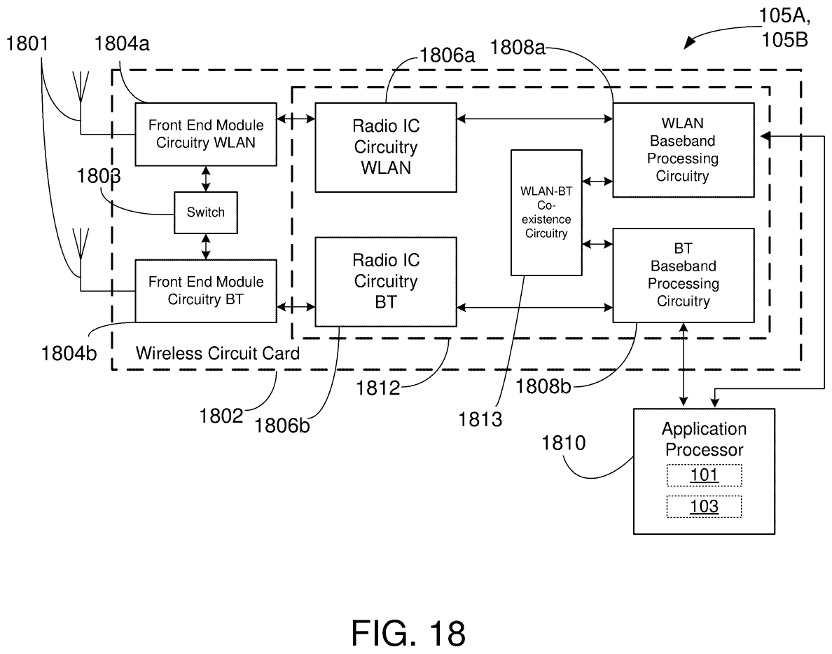

FIG. 18 is a block diagram of a radio architecture 105A, 105B in accordance with some embodiments that may be implemented in any one of the example APs 102 and/or the example STAs 120 of FIG. 1. Radio architecture 105A, 105B may include radio front-end module (FEM) circuitry 1804a-b, radio IC circuitry 1806a-b and baseband processing circuitry 1808a-b. Radio architecture 105A, 105B as shown includes both Wireless Local Area Network (WLAN) functionality and Bluetooth (BT) functionality although embodiments are not so limited. In this disclosure, “WLAN” and “Wi-Fi” are used interchangeably. FEM circuitry 1804a-b may include a WLAN or Wi-Fi FEM circuitry 1804a and a Bluetooth (BT) FEM circuitry 1804b. The WLAN FEM circuitry 1804a may include a receive signal path comprising circuitry configured to operate on WLAN RF signals received from one or more antennas 1801, to amplify the received signals and to provide the amplified versions of the received signals to the WLAN radio IC circuitry 1806a for further processing. The BT FEM circuitry 1804b may include a receive signal path which may include circuitry configured to operate on BT RF signals received from one or more antennas 1801, to amplify the received signals and to provide the amplified versions of the received signals to the BT radio IC circuitry 1806b for further processing. FEM circuitry 1804a may also include a transmit signal path which may include circuitry configured to amplify WLAN signals provided by the radio IC circuitry 1806a for wireless transmission by one or more of the antennas 1801. In addition, FEM circuitry 1804b may also include a transmit signal path which may include circuitry configured to amplify BT signals provided by the radio IC circuitry 1806b for wireless transmission by the one or more antennas.

In the embodiment of FIG. 18, although FEM 1804a and FEM 1804b are shown as being distinct from one another, embodiments are not so limited, and include within their scope the use of an FEM (not shown) that includes a transmit path and/or a receive path for both WLAN and BT signals, or the use of one or more FEM circuitries where at least some of the FEM circuitries share transmit and/or receive signal paths for both WLAN and BT signals. Radio IC circuitry 1806a-b as shown may include WLAN radio IC circuitry 1806a and BT radio IC circuitry 1806b. The WLAN radio IC circuitry 1806a may include a receive signal path which may include circuitry to down-convert WLAN RF signals received from the FEM circuitry 1804a and provide baseband signals to WLAN baseband processing circuitry 1808a. BT radio IC circuitry 1806b may in turn include a receive signal path which may include circuitry to down-convert BT RF signals received from the FEM circuitry 1804b and provide baseband signals to BT baseband processing circuitry 1808b.

WLAN radio IC circuitry 1806a may also include a transmit signal path which may include circuitry to up-convert WLAN baseband signals provided by the WLAN baseband processing circuitry 1808a and provide WLAN RF output signals to the FEM circuitry 1804a for subsequent wireless transmission by the one or more antennas 1801. BT radio IC circuitry 1806b may also include a transmit signal path which may include circuitry to up-convert BT baseband signals provided by the BT baseband processing circuitry 1808b and provide BT RF output signals to the FEM circuitry 1804b for subsequent wireless transmission by the one or more antennas 1801. In the embodiment of FIG. 18, although radio IC circuitries 1806a and 1806b are shown as being distinct from one another, embodiments are not so limited, and include within their scope the use of a radio IC circuitry (not shown) that includes a transmit signal path and/or a receive signal path for both WLAN and BT signals, or the use of one or more radio IC circuitries where at least some of the radio IC circuitries share transmit and/or receive signal paths for both WLAN and BT signals.

Baseband processing circuitry 1808a-b may include a WLAN baseband processing circuitry 1808a and a BT baseband processing circuitry 1808b. The WLAN baseband processing circuitry 1808a may include a memory, such as, for example, a set of RAM arrays in a Fast Fourier Transform or Inverse Fast Fourier Transform block (not shown) of the WLAN baseband processing circuitry 1808a. Each of the WLAN baseband circuitry 1808a and the BT baseband circuitry 1808b may further include one or more processors and control logic to process the signals received from the corresponding WLAN or BT receive signal path of the radio IC circuitry 1806a-b, and to also generate corresponding WLAN or BT baseband signals for the transmit signal path of the radio IC circuitry 1806a-b. Each of the baseband processing circuitries 1808a and 1808b may further include physical layer (PHY) and medium access control layer (MAC) circuitry, and may further interface with a device for generation and processing of the baseband signals and for controlling operations of the radio IC circuitry 1806a-b.

Referring still to FIG. 18, according to the shown embodiment, WLAN-BT coexistence circuitry 1813 may include logic providing an interface between the WLAN baseband circuitry 1808a and the BT baseband circuitry 1808b to enable use cases requiring WLAN and BT coexistence. In addition, a switch 1803 may be provided between the WLAN FEM circuitry 1804a and the BT FEM circuitry 1804b to allow switching between the WLAN and BT radios according to application needs. In addition, although the antennas 1801 are depicted as being respectively connected to the WLAN FEM circuitry 1804a and the BT FEM circuitry 1804b, embodiments include within their scope the sharing of one or more antennas as between the WLAN and BT FEMs, or the provision of more than one antenna connected to each of FEM 1804a or 1804b.

In some embodiments, the front-end module circuitry 1804a-b, the radio IC circuitry 1806a-b, and baseband processing circuitry 1808a-b may be provided on a single radio card, such as wireless radio card 1802. In some other embodiments, the one or more antennas 1801, the FEM circuitry 1804a-b and the radio IC circuitry 1806a-b may be provided on a single radio card. In some other embodiments, the radio IC circuitry 1806a-b and the baseband processing circuitry 1808a-b may be provided on a single chip or integrated circuit (IC), such as IC 1812. In some embodiments, the wireless radio card 1802 may include a WLAN radio card and may be configured for Wi-Fi communications, although the scope of the embodiments is not limited in this respect. In some of these embodiments, the radio architecture 105A, 105B may be configured to receive and transmit orthogonal frequency division multiplexed (OFDM) or orthogonal frequency division multiple access (OFDMA) communication signals over a multicarrier communication channel. The OFDM or OFDMA signals may comprise a plurality of orthogonal subcarriers. In some of these multicarrier embodiments, radio architecture 105A, 105B may be part of a Wi-Fi communication station (STA) such as a wireless access point (AP), a base station or a mobile device including a Wi-Fi device.

In some of these embodiments, radio architecture 105A, 105B may be configured to transmit and receive signals in accordance with specific communication standards and/or protocols, such as any of the Institute of Electrical and Electronics Engineers (IEEE) standards including, 802.11n-2009, IEEE 802.11-2012, IEEE 802.11-2016, 802.11n-2009, 802.11ac, 802.11ah, 802.11ad, 802.11ad, 802.11ay and/or 802.11ax standards and/or proposed specifications for WLANs, although the scope of embodiments is not limited in this respect. Radio architecture 105A, 105B may also be suitable to transmit and/or receive communications in accordance with other techniques and standards. In some embodiments, the radio architecture 105A, 105B may be configured for high-efficiency Wi-Fi (HEW) communications in accordance with the IEEE 802.11ax standard. In these embodiments, the radio architecture 105A, 105B may be configured to communicate in accordance with an OFDMA technique, although the scope of the embodiments is not limited in this respect. In some other embodiments, the radio architecture 105A, 105B may be configured to transmit and receive signals transmitted using one or more other modulation techniques such as spread spectrum modulation (e.g., direct sequence code division multiple access (DS-CDMA) and/or frequency hopping code division multiple access (FH-CDMA)), time-division multiplexing (TDM) modulation, and/or frequency-division multiplexing (FDM) modulation, although the scope of the embodiments is not limited in this respect.

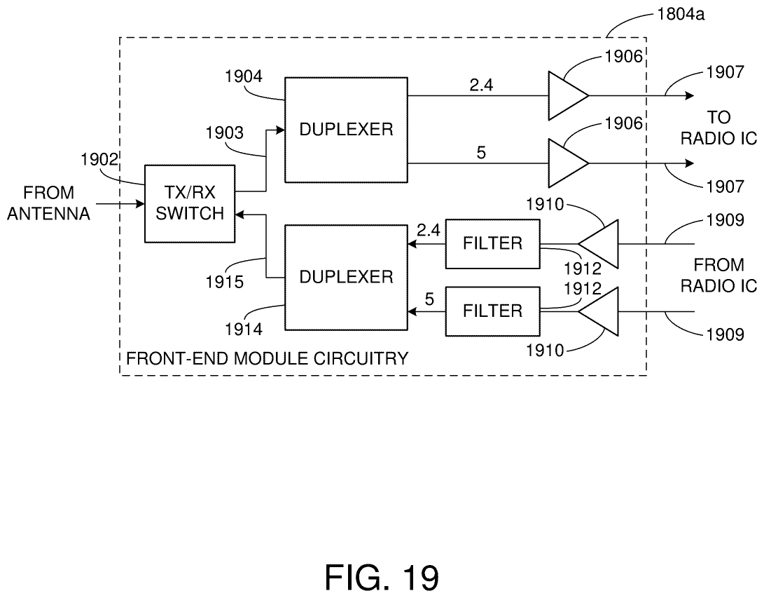

In some embodiments, as further shown in FIG. 19, the BT baseband circuitry 1808b may be compliant with a Bluetooth (BT) connectivity standard such as Bluetooth, Bluetooth 18.0 or Bluetooth 19.0, or any other iteration of the Bluetooth Standard. In some embodiments, the radio architecture 105A, 105B may include other radio cards, such as a cellular radio card configured for cellular (e.g., 5GPP such as LTE, LTE-Advanced or 20G communications). In some IEEE 802.11 embodiments, the radio architecture 105A, 105B may be configured for communication over various channel bandwidths including bandwidths having center frequencies of about 900 MHz, 2.4 GHz, 5 GHz, and bandwidths of about 2 MHz, 4 MHz, 5 MHz, 5.5 MHz, 6 MHz, 8 MHz, 10 MHz, 20 MHz, 40 MHz, 80 MHz (with contiguous bandwidths) or 80+80 MHz (160 MHz) (with non-contiguous bandwidths). In some embodiments, a 920 MHz channel bandwidth may be used. The scope of the embodiments is not limited with respect to the above center frequencies however.

FIG. 19 illustrates WLAN FEM circuitry 1804a in accordance with some embodiments. Although the example of FIG. 19 is described in conjunction with the WLAN FEM circuitry 1804a, the example of FIG. 19 may be described in conjunction with the example BT FEM circuitry 1804b (FIG. 18), although other circuitry configurations may also be suitable. In some embodiments, the FEM circuitry 1804a may include a TX/RX switch 1902 to switch between transmit mode and receive mode operation. The FEM circuitry 1804a may include a receive signal path and a transmit signal path. The receive signal path of the FEM circuitry 1804a may include a low-noise amplifier (LNA) 1906 to amplify received RF signals 1903 and provide the amplified received RF signals 1907 as an output (e.g., to the radio IC circuitry 1806a-b (FIG. 18)). The transmit signal path of the circuitry 1804a may include a power amplifier (PA) to amplify input RF signals 1909 (e.g., provided by the radio IC circuitry 1806a-b), and one or more filters 1912, such as band-pass filters (BPFs), low-pass filters (LPFs) or other types of filters, to generate RF signals 1915 for subsequent transmission (e.g., by one or more of the antennas 1801 (FIG. 18)) via an example duplexer 1914.

In some dual-mode embodiments for Wi-Fi communication, the FEM circuitry 1804a may be configured to operate in either the 2.4 GHz frequency spectrum or the 5 GHz frequency spectrum. In these embodiments, the receive signal path of the FEM circuitry 1804a may include a receive signal path duplexer 1904 to separate the signals from each spectrum as well as provide a separate LNA 1906 for each spectrum as shown. In these embodiments, the transmit signal path of the FEM circuitry 1804a may also include a power amplifier 1910 and a filter 1912, such as a BPF, an LPF or another type of filter for each frequency spectrum and a transmit signal path duplexer 1904 to provide the signals of one of the different spectrums onto a single transmit path for subsequent transmission by the one or more of the antennas 1801 (FIG. 18). In some embodiments, BT communications may utilize the 2.4 GHz signal paths and may utilize the same FEM circuitry 1804a as the one used for WLAN communications.

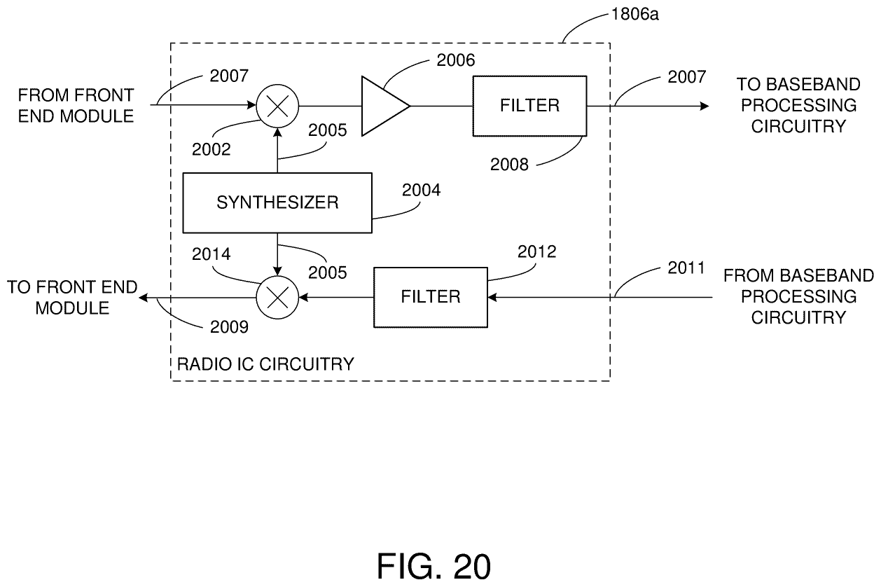

FIG. 20 illustrates radio IC circuitry 1806a in accordance with some embodiments. The radio IC circuitry 1806a is one example of circuitry that may be suitable for use as the WLAN or BT radio IC circuitry 1806a/1806b (FIG. 18), although other circuitry configurations may also be suitable. Alternatively, the example of FIG. 20 may be described in conjunction with the example BT radio IC circuitry 1806b. In some embodiments, the radio IC circuitry 1806a may include a receive signal path and a transmit signal path. The receive signal path of the radio IC circuitry 1806a may include at least mixer circuitry 2002, such as, for example, down-conversion mixer circuitry, amplifier circuitry 2006 and filter circuitry 2008. The transmit signal path of the radio IC circuitry 1806a may include at least filter circuitry 2012 and mixer circuitry 2014, such as, for example, up-conversion mixer circuitry.

Radio IC circuitry 1806a may also include synthesizer circuitry 2004 for synthesizing a frequency 2005 for use by the mixer circuitry 2002 and the mixer circuitry 2014. The mixer circuitry 2002 and/or 2014 may each, according to some embodiments, be configured to provide direct conversion functionality. The latter type of circuitry presents a much simpler architecture as compared with standard super-heterodyne mixer circuitries, and any flicker noise brought about by the same may be alleviated for example through the use of OFDM modulation. FIG. 20 illustrates only a simplified version of a radio IC circuitry, and may include, although not shown, embodiments where each of the depicted circuitries may include more than one component. For instance, mixer circuitry 2014 may each include one or more mixers, and filter circuitries 2008 and/or 2012 may each include one or more filters, such as one or more BPFs and/or LPFs according to application needs.

For example, when mixer circuitries are of the direct-conversion type, they may each include two or more mixers. In some embodiments, mixer circuitry 2002 may be configured to down-convert RF signals 1907 received from the FEM circuitry 1804a-b (FIG. 18) based on the synthesized frequency 2005 provided by synthesizer circuitry 2004. The amplifier circuitry 2006 may be configured to amplify the down-converted signals and the filter circuitry 2008 may include an LPF configured to remove unwanted signals from the down-converted signals to generate output baseband signals 2007. Output baseband signals 2007 may be provided to the baseband processing circuitry 1808a-b (FIG. 18) for further processing.

In some embodiments, the output baseband signals 2007 may be zero-frequency baseband signals, although this is not a requirement. In some embodiments, mixer circuitry 2002 may comprise passive mixers, although the scope of the embodiments is not limited in this respect. In some embodiments, the mixer circuitry 2014 may be configured to up-convert input baseband signals 2011 based on the synthesized frequency 2005 provided by the synthesizer circuitry 2004 to generate RF output signals 1909 for the FEM circuitry 1804a-b. The baseband signals 2011 may be provided by the baseband processing circuitry 1808a-b and may be filtered by filter circuitry 2012. The filter circuitry 2012 may include an LPF or a BPF, although the scope of the embodiments is not limited in this respect.

In some embodiments, the mixer circuitry 2002 and the mixer circuitry 2014 may each include two or more mixers and may be arranged for quadrature down-conversion and/or up-conversion respectively with the help of synthesizer 2004. In some embodiments, the mixer circuitry 2002 and the mixer circuitry 2014 may each include two or more mixers each configured for image rejection (e.g., Hartley image rejection). In some embodiments, the mixer circuitry 2002 and the mixer circuitry 2014 may be arranged for direct down-conversion and/or direct up-conversion, respectively. In some embodiments, the mixer circuitry 2002 and the mixer circuitry 2014 may be configured for super-heterodyne operation, although this is not a requirement.

Mixer circuitry 2002 may comprise, according to one embodiment: quadrature passive mixers (e.g., for the in-phase (I) and quadrature phase (Q) paths). In such an embodiment, RF input signal 1907 from FIG. 20 may be down-converted to provide I and Q baseband output signals to be sent to the baseband processor. Quadrature passive mixers may be driven by zero and ninety-degree time-varying LO switching signals provided by a quadrature circuitry which may be configured to receive a LO frequency (fLO) from a local oscillator or a synthesizer, such as LO frequency 2005 of synthesizer 2004 (FIG. 20). In some embodiments, the LO frequency may be the carrier frequency, while in other embodiments, the LO frequency may be a fraction of the carrier frequency (e.g., one-half the carrier frequency, one-third the carrier frequency). In some embodiments, the zero and ninety-degree time-varying switching signals may be generated by the synthesizer, although the scope of the embodiments is not limited in this respect.

In some embodiments, the LO signals may differ in duty cycle (the percentage of one period in which the LO signal is high) and/or offset (the difference between start points of the period). In some embodiments, the LO signals may have an 85% duty cycle and an 80% offset. In some embodiments, each branch of the mixer circuitry (e.g., the in-phase (I) and quadrature phase (Q) path) may operate at an 80% duty cycle, which may result in a significant reduction in power consumption. The RF input signal 1907 (FIG. 19) may comprise a balanced signal, although the scope of the embodiments is not limited in this respect. The I and Q baseband output signals may be provided to low-noise amplifier, such as amplifier circuitry 2006 (FIG. 20) or to filter circuitry 2008 (FIG. 20).

In some embodiments, the output baseband signals 2007 and the input baseband signals 2011 may be analog baseband signals, although the scope of the embodiments is not limited in this respect. In some alternate embodiments, the output baseband signals 2007 and the input baseband signals 2011 may be digital baseband signals. In these alternate embodiments, the radio IC circuitry may include analog-to-digital converter (ADC) and digital-to-analog converter (DAC) circuitry. In some dual-mode embodiments, a separate radio IC circuitry may be provided for processing signals for each spectrum, or for other spectrums not mentioned here, although the scope of the embodiments is not limited in this respect.

In some embodiments, the synthesizer circuitry 2004 may be a fractional-N synthesizer or a fractional N/N+1 synthesizer, although the scope of the embodiments is not limited in this respect as other types of frequency synthesizers may be suitable. For example, synthesizer circuitry 2004 may be a delta-sigma synthesizer, a frequency multiplier, or a synthesizer comprising a phase-locked loop with a frequency divider. According to some embodiments, the synthesizer circuitry 2004 may include digital synthesizer circuitry. An advantage of using a digital synthesizer circuitry is that, although it may still include some analog components, its footprint may be scaled down much more than the footprint of an analog synthesizer circuitry.

In some embodiments, frequency input into synthesizer circuitry 2004 may be provided by a voltage controlled oscillator (VCO), although that is not a requirement. A divider control input may further be provided by either the baseband processing circuitry 1808a-b (FIG. 18) depending on the desired output frequency 2005. In some embodiments, a divider control input (e.g., N) may be determined from a look-up table (e.g., within a Wi-Fi card) based on a channel number and a channel center frequency as determined or indicated by the example application processor 1810. The application processor 1810 may include, or otherwise be connected to, one of the example secure signal converter 101 or the example received signal converter 103 (e.g., depending on which device the example radio architecture is implemented in).

In some embodiments, synthesizer circuitry 2004 may be configured to generate a carrier frequency as the output frequency 2005, while in other embodiments, the output frequency 2005 may be a fraction of the carrier frequency (e.g., one-half the carrier frequency, one-third the carrier frequency). In some embodiments, the output frequency 2005 may be a LO frequency (fLO).

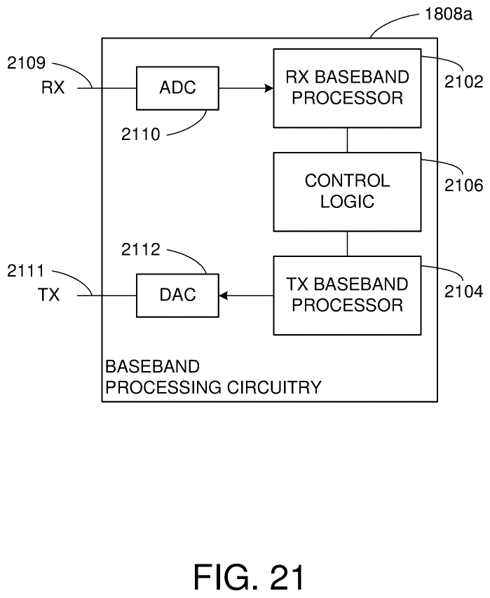

FIG. 21 illustrates a functional block diagram of baseband processing circuitry 1808a in accordance with some embodiments. The baseband processing circuitry 1808a is one example of circuitry that may be suitable for use as the baseband processing circuitry 1808a (FIG. 18), although other circuitry configurations may also be suitable. Alternatively, the example of FIG. 20 may be used to implement the example BT baseband processing circuitry 1808b of FIG. 18. The baseband processing circuitry 1808a may include a receive baseband processor (RX BBP) 2102 for processing receive baseband signals 2009 provided by the radio IC circuitry 1806a-b (FIG. 18) and a transmit baseband processor (TX BBP) 2104 for generating transmit baseband signals 2011 for the radio IC circuitry 1806a-b.

The baseband processing circuitry 1808a may also include control logic 2106 for coordinating the operations of the baseband processing circuitry 1808a. In some embodiments (e.g., when analog baseband signals are exchanged between the baseband processing circuitry 1808a-b and the radio IC circuitry 1806a-b), the baseband processing circuitry 1808a may include ADC 2110 to convert analog baseband signals 2109 received from the radio IC circuitry 1806a-b to digital baseband signals for processing by the RX BBP 2102. In these embodiments, the baseband processing circuitry 1808a may also include DAC 2112 to convert digital baseband signals from the TX BBP 2104 to analog baseband signals 2111.

In some embodiments that communicate OFDM signals or OFDMA signals, such as through baseband processor 1808a, the transmit baseband processor 2104 may be configured to generate OFDM or OFDMA signals as appropriate for transmission by performing an inverse fast Fourier transform (IFFT). The receive baseband processor 2102 may be configured to process received OFDM signals or OFDMA signals by performing an FFT. In some embodiments, the receive baseband processor 2102 may be configured to detect the presence of an OFDM signal or OFDMA signal by performing an autocorrelation, to detect a preamble, such as a short preamble, and by performing a cross-correlation, to detect a long preamble. The preambles may be part of a predetermined frame structure for Wi-Fi communication.

Referring back to FIG. 18, in some embodiments, the antennas 1801 (FIG. 18) may each comprise one or more directional or omnidirectional antennas, including, for example, dipole antennas, monopole antennas, patch antennas, loop antennas, microstrip antennas or other types of antennas suitable for transmission of RF signals. In some multiple-input multiple-output (MIMO) embodiments, the antennas may be effectively separated to take advantage of spatial diversity and the different channel characteristics that may result. Antennas 1801 may each include a set of phased-array antennas, although embodiments are not so limited.

Although the radio architecture 105A, 105B is illustrated as having several separate functional elements, one or more of the functional elements may be combined and may be implemented by combinations of software-configured elements, such as processing elements including digital signal processors (DSPs), and/or other hardware elements. For example, some elements may comprise one or more microprocessors, DSPs, field-programmable gate arrays (FPGAs), application specific integrated circuits (ASICs), radio-frequency integrated circuits (RFICs) and combinations of various hardware and logic circuitry for performing at least the functions described herein. In some embodiments, the functional elements may refer to one or more processes operating on one or more processing elements.

The word “exemplary” is used herein to mean “serving as an example, instance, or illustration.” Any embodiment described herein as “exemplary” is not necessarily to be construed as preferred or advantageous over other embodiments. The terms “computing device,” “user device,” “communication station,” “station,” “handheld device,” “mobile device,” “wireless device” and “user equipment” (UE) as used herein refers to a wireless communication device such as a cellular telephone, a smartphone, a tablet, a netbook, a wireless terminal, a laptop computer, a femtocell, a high data rate (HDR) subscriber station, an access point, a printer, a point of sale device, an access terminal, or other personal communication system (PCS) device. The device may be either mobile or stationary.

As used within this document, the term “communicate” is intended to include transmitting, or receiving, or both transmitting and receiving. This may be particularly useful in claims when describing the organization of data that is being transmitted by one device and received by another, but only the functionality of one of those devices is required to infringe the claim. Similarly, the bidirectional exchange of data between two devices (both devices transmit and receive during the exchange) may be described as “communicating,” when only the functionality of one of those devices is being claimed. The term “communicating” as used herein with respect to a wireless communication signal includes transmitting the wireless communication signal and/or receiving the wireless communication signal. For example, a wireless communication unit, which is capable of communicating a wireless communication signal, may include a wireless transmitter to transmit the wireless communication signal to at least one other wireless communication unit, and/or a wireless communication receiver to receive the wireless communication signal from at least one other wireless communication unit.

As used herein, unless otherwise specified, the use of the ordinal adjectives “first,” “second,” “third,” etc., to describe a common object, merely indicates that different instances of like objects are being referred to and are not intended to imply that the objects so described must be in a given sequence, either temporally, spatially, in ranking, or in any other manner.

The term “access point” (AP) as used herein may be a fixed station. An access point may also be referred to as an access node, a base station, an evolved node B (eNodeB), or some other similar terminology known in the art. An access terminal may also be called a mobile station, user equipment (UE), a wireless communication device, or some other similar terminology known in the art. Embodiments disclosed herein generally pertain to wireless networks. Some embodiments may relate to wireless networks that operate in accordance with one of the IEEE 802.11 standards.

Some embodiments may be used in conjunction with various devices and systems, for example, a personal computer (PC), a desktop computer, a mobile computer, a laptop computer, a notebook computer, a tablet computer, a server computer, a handheld computer, a handheld device, a personal digital assistant (PDA) device, a handheld PDA device, an on-board device, an off-board device, a hybrid device, a vehicular device, a non-vehicular device, a mobile or portable device, a consumer device, a non-mobile or non-portable device, a wireless communication station, a wireless communication device, a wireless access point (AP), a wired or wireless router, a wired or wireless modem, a video device, an audio device, an audio-video (A/V) device, a wired or wireless network, a wireless area network, a wireless video area network (WVAN), a local area network (LAN), a wireless LAN (WLAN), a personal area network (PAN), a wireless PAN (WPAN), and the like.

Some embodiments may be used in conjunction with one way and/or two-way radio communication systems, cellular radio-telephone communication systems, a mobile phone, a cellular telephone, a wireless telephone, a personal communication system (PCS) device, a PDA device which incorporates a wireless communication device, a mobile or portable global positioning system (GPS) device, a device which incorporates a GPS receiver or transceiver or chip, a device which incorporates an RFID element or chip, a multiple input multiple output (MIMO) transceiver or device, a single input multiple output (SIMO) transceiver or device, a multiple input single output (MISO) transceiver or device, a device having one or more internal antennas and/or external antennas, digital video broadcast (DVB) devices or systems, multi-standard radio devices or systems, a wired or wireless handheld device, e.g., a smartphone, a wireless application protocol (WAP) device, or the like.

Some embodiments may be used in conjunction with one or more types of wireless communication signals and/or systems following one or more wireless communication protocols, for example, radio frequency (RF), infrared (IR), frequency-division multiplexing (FDM), orthogonal FDM (OFDM), time-division multiplexing (TDM), time-division multiple access (TDMA), extended TDMA (E-TDMA), general packet radio service (GPRS), extended GPRS, code-division multiple access (CDMA), wideband CDMA (WCDMA), CDMA 2000, single-carrier CDMA, multi-carrier CDMA, multi-carrier modulation (MDM), discrete multi-tone (DMT), Bluetooth®, global positioning system (GPS), Wi-Fi, Wi-Max, ZigBee, ultra-wideband (UWB), global system for mobile communications (GSM), 2G, 2.5G, 3G, 3.5G, 4G, fifth generation (5G) mobile networks, 3GPP, long term evolution (LTE), LTE advanced, enhanced data rates for GSM Evolution (EDGE), or the like. Other embodiments may be used in various other devices, systems, and/or networks.

The following examples pertain to further embodiments.

Example 1 may include a device including processing circuitry coupled to storage, the processing circuitry configured to: generate an invitation frame comprising information associated with synchronized transmissions between the device and a shared access point (AP); cause to send the invitation frame to the shared AP, the invitation frame inviting the shared AP to synchronize transmissions with the device using coordinated beamforming or coordinated spatial reuse based on the information; identify a response frame received from the shared AP and indicating that the shared AP has accepted the invitation to coordinate transmissions with the device based on the information; cause to send a trigger frame, based on the response frame, associated with synchronizing downlink transmissions with the shared AP based on the information; and cause to send, based on the information, a first downlink physical layer protocol data unit (PPDU) in synchronization with a second downlink PPDU of the shared AP.

Example 2 may include the device of example 1 and/or any other example herein, wherein the information includes a minimum number of data orthogonal frequency division multiplex (OFDM) symbols of the synchronized transmissions and a minimum number of data OFDM symbols of the synchronized transmissions.

Example 3 may include the device of example 1 and/or any other example herein, wherein the information includes a physical layer (PHY) version of the synchronized transmissions, a bandwidth used by the synchronized transmissions, a puncturing pattern of the synchronized transmissions, and a guard interval and long training field size of the synchronized transmissions.

Example 4 may include the device of example 1 and/or any other example herein, wherein the information includes a maximum total number of spatial streams allowed for the second downlink PPDU, a number of recipient station devices (STAs) of the synchronized transmissions that are associated with the device, and an STA identifier of each of the recipient STAs.

Example 5 may include the device of example 1 and/or any other example herein, wherein the information includes a number of spatial streams for each recipient STA associated with the device.

Example 6 may include the device of example 1 and/or any other example herein, wherein the information includes an indication that an exchange of an initial control frame and an initial control response between the device and any STAs to receive the first downlink PPDU is to precede the first downlink PPDU, and a duration of the exchange.

Example 7 may include the device of example 1 and/or any other example herein, wherein the invitation frame indicates that the downlink transmissions are to use coordinated beamforming, a first type of spatial reuse, or a second type of spatial reuse.

Example 8 may include the device of example 1, wherein the invitation frame and the trigger frame are unicast frames including a medium access control (MAC) address of the shared AP as a receiver address, and wherein the response frame is a unicast frame including a MAC address of the device as a receiver address.

Example 9 may include the device of example 1 and/or any other example herein, wherein the response frame is included in a multi-STA block acknowledgement (BA) frame.

Example 10 may include the device of example 1 and/or any other example herein, wherein the trigger frame comprises all required physical layer configuration information for transmitting and receiving the first downlink PPDU and the second downlink PPDU, based on the exchanged information.

Example 11 may include the device of example 1 and/or any other example herein, further including a transceiver configured to transmit and receive wireless signals comprising the invitation frame, the response frame, the trigger frame, the first downlink PPDU, and the second downlink PPDU.

Example 12 may include the device of example 11 and/or any other example herein, further including an antenna coupled to the transceiver to cause to send the invitation frame, the trigger frame, and the first downlink PPDU.

Example 13 may include a non-transitory computer-readable medium storing computer-executable instructions which when executed by one or more processors of a device result in performing operations including to: generate an invitation frame including information associated with synchronized transmissions between the device and a shared access point (AP); cause to send the invitation frame to the shared AP, the invitation frame inviting the shared AP to synchronize transmissions with the device using coordinated beamforming or coordinated spatial reuse based on the information; identify a response frame received from the shared AP and indicating that the shared AP has accepted the invitation to coordinate transmissions with the device based on the information; cause to send a trigger frame, based on the response frame, associated with synchronizing downlink transmissions with the shared AP based on the information; and cause to send, based on the information, a first downlink physical layer protocol data unit (PPDU) in synchronization with a second downlink PPDU of the shared AP.

Example 14 may include the non-transitory computer-readable medium of example 13 and/or any other example herein, wherein the information includes a minimum number of data orthogonal frequency division multiplex (OFDM) symbols of the synchronized transmissions, a minimum number of data OFDM symbols of the synchronized transmissions, a physical layer (PHY) version of the synchronized transmissions, a bandwidth used by the synchronized transmissions, a puncturing pattern of the synchronized transmissions, a guard interval and long training field size of the synchronized transmissions, a modulation and coding scheme (MCS), and a 2× low-density parity check (LDPC).

Example 15 may include the non-transitory computer-readable medium of example 13 and/or any other example herein, wherein the information including a maximum total number of spatial streams allowed for the second downlink PPDU, a number of recipient station devices (STAs) of the synchronized transmissions that are associated with the device, an STA identifier of each of the recipient STAs, and a number of spatial streams for each recipient STA associated with the device.

Example 16 may include the non-transitory computer-readable medium of example 13 and/or any other example herein, wherein the information includes an indication that an exchange of an initial control frame and an initial control response between the device and any STAs to receive the first downlink PPDU is to precede the first downlink PPDU, and a duration of the exchange.

Example 17 may include the non-transitory computer-readable medium of example 13 and/or any other example herein, wherein the invitation frame indicates that the downlink transmissions are to use coordinated beamforming, a first type of spatial reuse, or a second type of spatial reuse.

Example 18 may include the non-transitory computer-readable medium of example 13 and/or any other example herein, wherein the invitation frame and the trigger frame are unicast frames including a medium access control (MAC) address of the shared AP as a receiver address, and wherein the response frame is a unicast frame including a MAC address of the device as a receiver address.

Example 19 may include the non-transitory computer-readable medium of example 13 and/or any other example herein, wherein the response frame is included in a multi-STA block acknowledgement (BA) frame.

Example 20 may include a method including: generating, by processing circuitry of a first device, an invitation frame including information associated with synchronized transmissions between the device and a shared access point (AP); causing to send, by the processing circuitry, the invitation frame to the shared AP, the invitation frame inviting the shared AP to synchronize transmissions with the device using coordinated beamforming or coordinated spatial reuse based on the information; identifying, by the processing circuitry, a response frame received from the shared AP and indicating that the shared AP has accepted the invitation to coordinate transmissions with the device based on the information; causing to send, by the processing circuitry, a trigger frame, based on the response frame, associated with synchronizing downlink transmissions with the shared AP based on the information; and causing to send, by the processing circuitry and based on the information, a first downlink physical layer protocol data unit (PPDU) in synchronization with a second downlink PPDU of the shared AP.

Example 21 may include an apparatus including means for: generating, using a first device, an invitation frame including information associated with synchronized transmissions between the device and a shared access point (AP); causing to send the invitation frame to the shared AP, the invitation frame inviting the shared AP to synchronize transmissions with the device using coordinated beamforming or coordinated spatial reuse based on the information; identifying a response frame received from the shared AP and indicating that the shared AP has accepted the invitation to coordinate transmissions with the device based on the information; causing to send a trigger frame, based on the response frame, associated with synchronizing downlink transmissions with the shared AP based on the information; and causing to send, based on the information, a first downlink physical layer protocol data unit (PPDU) in synchronization with a second downlink PPDU of the shared AP.

Example 22 may include one or more non-transitory computer-readable media comprising instructions to cause an electronic device, upon execution of the instructions by one or more processors of the electronic device, to perform one or more elements of a method described in or related to any of examples 1-21, or any other method or process described herein.

Example 23 may include an apparatus comprising logic, modules, and/or circuitry to perform one or more elements of a method described in or related to any of examples 1-21, or any other method or process described herein.

Example 24 may include a method, technique, or process as described in or related to any of examples 1-21, or portions or parts thereof.

Example 25 may include an apparatus comprising: one or more processors and one or more computer readable media comprising instructions that, when executed by the one or more processors, cause the one or more processors to perform the method, techniques, or process as described in or related to any of examples 1-21, or portions thereof.

Example 26 may include a method of communicating in a wireless network as shown and described herein.

Example 27 may include a system for providing wireless communication as shown and described herein.

Example 28 may include a device for providing wireless communication as shown and described herein.

Embodiments according to the disclosure are in particular disclosed in the attached claims directed to a method, a storage medium, a device and a computer program product, wherein any feature mentioned in one claim category, e.g., method, can be claimed in another claim category, e.g., system, as well. The dependencies or references back in the attached claims are chosen for formal reasons only. However, any subject matter resulting from a deliberate reference back to any previous claims (in particular multiple dependencies) can be claimed as well, so that any combination of claims and the features thereof are disclosed and can be claimed regardless of the dependencies chosen in the attached claims. The subject-matter which can be claimed comprises not only the combinations of features as set out in the attached claims but also any other combination of features in the claims, wherein each feature mentioned in the claims can be combined with any other feature or combination of other features in the claims. Furthermore, any of the embodiments and features described or depicted herein can be claimed in a separate claim and/or in any combination with any embodiment or feature described or depicted herein or with any of the features of the attached claims.

The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Certain aspects of the disclosure are described above with reference to block and flow diagrams of systems, methods, apparatuses, and/or computer program products according to various implementations. It will be understood that one or more blocks of the block diagrams and flow diagrams, and combinations of blocks in the block diagrams and the flow diagrams, respectively, may be implemented by computer-executable program instructions. Likewise, some blocks of the block diagrams and flow diagrams may not necessarily need to be performed in the order presented, or may not necessarily need to be performed at all, according to some implementations.

These computer-executable program instructions may be loaded onto a special-purpose computer or other particular machine, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable storage media or memory that may direct a computer or other programmable data processing apparatus to function in a particular manner, such that the instructions stored in the computer-readable storage media produce an article of manufacture including instruction means that implement one or more functions specified in the flow diagram block or blocks. As an example, certain implementations may provide for a computer program product, comprising a computer-readable storage medium having a computer-readable program code or program instructions implemented therein, said computer-readable program code adapted to be executed to implement one or more functions specified in the flow diagram block or blocks. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions and program instruction means for performing the specified functions. It will also be understood that each block of the block diagrams and flow diagrams, and combinations of blocks in the block diagrams and flow diagrams, may be implemented by special-purpose, hardware-based computer systems that perform the specified functions, elements or steps, or combinations of special-purpose hardware and computer instructions.

Conditional language, such as, among others, “can,” “could,” “might,” or “may,” unless specifically stated otherwise, or otherwise understood within the context as used, is generally intended to convey that certain implementations could include, while other implementations do not include, certain features, elements, and/or operations. Thus, such conditional language is not generally intended to imply that features, elements, and/or operations are in any way required for one or more implementations or that one or more implementations necessarily include logic for deciding, with or without user input or prompting, whether these features, elements, and/or operations are included or are to be performed in any particular implementation.

Many modifications and other implementations of the disclosure set forth herein will be apparent having the benefit of the teachings presented in the foregoing descriptions and the associated drawings. Therefore, it is to be understood that the disclosure is not to be limited to the specific implementations disclosed and that modifications and other implementations are intended to be included within the scope of the appended claims. Although specific terms are employed herein, they are used in a generic and descriptive sense only and not for purposes of limitation.

What is claimed is:

1. A device comprising processing circuitry coupled to storage, the processing circuitry configured to:
generate an invitation frame comprising information associated with synchronized transmissions between the device and a shared access point (AP);
cause to send the invitation frame to the shared AP, the invitation frame inviting the shared AP to synchronize transmissions with the device using coordinated beamforming or coordinated spatial reuse based on the information;
identify a response frame received from the shared AP and indicating that the shared AP has accepted the invitation to coordinate transmissions with the device based on the information;
cause to send a trigger frame, based on the response frame, associated with synchronizing downlink transmissions with the shared AP based on the information; and
cause to send, based on the information, a first downlink physical layer protocol data unit (PPDU) in synchronization with a second downlink PPDU of the shared AP.

2. The device of claim 1, wherein the information comprises a minimum number of data orthogonal frequency division multiplex (OFDM) symbols of the synchronized transmissions and a minimum number of data OFDM symbols of the synchronized transmissions.

3. The device of claim 1, wherein the information comprises a physical layer (PHY) version of the synchronized transmissions, a bandwidth used by the synchronized transmissions, a puncturing pattern of the synchronized transmissions, and a guard interval and long training field size of the synchronized transmissions.

4. The device of claim 1, wherein the information comprises a maximum total number of spatial streams allowed for the second downlink PPDU, a number of recipient station devices (STAs) of the synchronized transmissions that are associated with the device, and an STA identifier of each of the recipient STAs.

5. The device of claim 1, wherein the information comprises a number of spatial streams for each recipient STA associated with the device.

6. The device of claim 1, wherein the information comprises an indication that an exchange of an initial control frame and an initial control response between the device and any STAs to receive the first downlink PPDU is to precede the first downlink PPDU, and a duration of the exchange.

7. The device of claim 1, wherein the invitation frame indicates that the downlink transmissions are to use coordinated beamforming, a first type of spatial reuse, or a second type of spatial reuse.

8. The device of claim 1, wherein the invitation frame and the trigger frame are unicast frames comprising a medium access control (MAC) address of the shared AP as a receiver address, and wherein the response frame is a unicast frame comprising a MAC address of the device as a receiver address.

9. The device of claim 1, wherein the response frame is included in a multi-STA block acknowledgement (BA) frame.

10. The device of claim 1, wherein the trigger frame comprises all required physical layer configuration information for transmitting and receiving the first downlink PPDU and the second downlink PPDU, based on the exchanged information.

11. The device of claim 1, further comprising a transceiver configured to transmit and receive wireless signals comprising the invitation frame, the response frame, the trigger frame, the first downlink PPDU, and the second downlink PPDU.

12. The device of claim 11, further comprising an antenna coupled to the transceiver to cause to send the invitation frame, the trigger frame, and the first downlink PPDU.

13. A non-transitory computer-readable medium storing computer-executable instructions which when executed by one or more processors of a device result in performing operations comprising to:
generate an invitation frame comprising information associated with synchronized transmissions between the device and a shared access point (AP);
cause to send the invitation frame to the shared AP, the invitation frame inviting the shared AP to synchronize transmissions with the device using coordinated beamforming or coordinated spatial reuse based on the information;
identify a response frame received from the shared AP and indicating that the shared AP has accepted the invitation to coordinate transmissions with the device based on the information;
cause to send a trigger frame, based on the response frame, associated with synchronizing downlink transmissions with the shared AP based on the information; and
cause to send, based on the information, a first downlink physical layer protocol data unit (PPDU) in synchronization with a second downlink PPDU of the shared AP.

14. The non-transitory computer-readable medium of claim 13, wherein the information comprises a minimum number of data orthogonal frequency division multiplex (OFDM) symbols of the synchronized transmissions, a minimum number of data OFDM symbols of the synchronized transmissions, a physical layer (PHY) version of the synchronized transmissions, a bandwidth used by the synchronized transmissions, a puncturing pattern of the synchronized transmissions, a guard interval and long training field size of the synchronized transmissions, a modulation and coding scheme (MCS), and a 2× low-density parity check (LDPC).

15. The non-transitory computer-readable medium of claim 13, wherein the information comprises a maximum total number of spatial streams allowed for the second downlink PPDU, a number of recipient station devices (STAs) of the synchronized transmissions that are associated with the device, an STA identifier of each of the recipient STAs, and a number of spatial streams for each recipient STA associated with the device.

16. The non-transitory computer-readable medium of claim 13, wherein the information comprises an indication that an exchange of an initial control frame and an initial control response between the device and any STAs to receive the first downlink PPDU is to precede the first downlink PPDU, and a duration of the exchange.

17. The non-transitory computer-readable medium of claim 13, wherein the invitation frame indicates that the downlink transmissions are to use coordinated beamforming, a first type of spatial reuse, or a second type of spatial reuse.

18. The non-transitory computer-readable medium of claim 13, wherein the invitation frame and the trigger frame are unicast frames comprising a medium access control (MAC) address of the shared AP as a receiver address, and wherein the response frame is a unicast frame comprising a MAC address of the device as a receiver address.

19. The non-transitory computer-readable medium of claim 13, wherein the response frame is included in a multi-STA block acknowledgement (BA) frame.

20. A method comprising:
generating, by processing circuitry of a first device, an invitation frame comprising information associated with synchronized transmissions between the device and a shared access point (AP);
causing to send, by the processing circuitry, the invitation frame to the shared AP, the invitation frame inviting the shared AP to synchronize transmissions with the device using coordinated beamforming or coordinated spatial reuse based on the information;
identifying, by the processing circuitry, a response frame received from the shared AP and indicating that the shared AP has accepted the invitation to coordinate transmissions with the device based on the information;
causing to send, by the processing circuitry, a trigger frame, based on the response frame, associated with synchronizing downlink transmissions with the shared AP based on the information; and
causing to send, by the processing circuitry and based on the information, a first downlink physical layer protocol data unit (PPDU) in synchronization with a second downlink PPDU of the shared AP.
